(19) United States
(12) Patent Application Publication
(10) Pub. No.: US 2026/0103237 A1
(43) Pub. Date: Apr. 16, 2026

(54) CONTROL DEVICE, MOTOR DEVICE, ELECTRIC POWER STEERING DEVICE, CONTROL METHOD, AND PROGRAM

(71) Applicant: NIDEC CORPORATION, Kyoto (JP)

(72) Inventors: Shuji ENDO, Kyoto (JP); Sohei MIYAKE, Kyoto (JP); Satoshi KAJIHARA, Kyoto (JP)

(21) Appl. No.: 19/352,664

(22) Filed: Oct. 8, 2025

Related U.S. Application Data
(60) Provisional application No. 63/705,666, filed on Oct. 10, 2024.

(30) Foreign Application Priority Data
Jan. 17, 2025 (JP) 2025-006972

(51) Int. Cl. B62D 6/00; B62D 5/04; B62D 15/02

(52) U.S. Cl. CPC B62D 6/008; B62D 5/0463; B62D 15/025

(57) ABSTRACT

A control device includes a model following controller configured or programmed to generate a correction torque to correct an input torque to be input to a control target based on a nominal model based on a configuration of the control target, and a calculator configured or programmed to calculate an input value to be input to the model following controller. The calculator is configured or programmed to execute first calculation processing to calculate the input value. In the first calculation processing, the calculator is configured or programmed to calculate the input value based on a first output value acquired based on a first sensor and indicating an output of the motor and a second output value acquired based on a second sensor and indicating an output of a decelerator.

### CROSS-REFERENCE TO RELATED APPLICATIONS

The present application is a non-provisional of U.S. Patent Application No. 63/705,666, filed on Oct. 10, 2024, and claims priority under 35 U.S.C. § 119 to Japanese Patent Application No. 2025-006972, filed on Jan. 17, 2025, the entire contents of which are hereby incorporated herein by reference.

### 1. FIELD OF THE INVENTION

The present disclosure relates to control devices, motor devices, electric power steering devices, control methods, and non-transitory computer-readable media including programs.

### 2. BACKGROUND

An electric power steering system mounted on a vehicle is known.

In the electric power steering system as described above, there is a case where model following control capable of constraining a transfer function of a control target to a transfer function of a nominal model is executed. In this case, the model following control can be executed more stably as the nominal model is brought closer to the control target to reduce the modeling error. However, there is a problem that the nominal model becomes more complicated as the nominal model approaches the control target, and the operation load of the control device increases.

### SUMMARY

A control device according to an example embodiment of the present disclosure controls, as a control target, a portion including a motor and a decelerator of an electric power steering device to be mounted on a vehicle, the electric power steering device including an input shaft to which a steering wheel to be steered by a steering operator is connected, an output shaft connected to the input shaft via a torsion bar, and the motor connected to the output shaft via the decelerator. The control device includes a model following controller configured or programmed to generate a correction torque to correct an input torque based on a nominal model based on the configuration of the control target, and a calculator configured or programmed to calculate an input value to be input to the model following controller. The model following controller is configured or programmed to include an inverse nominal model that is an inverse model of the nominal model and to which the input value is input, and is configured or programmed such that a transfer function of the control target is constrained to a transfer function of the nominal model in a frequency band in which a complementary sensitivity gain that is a gain in a gain characteristic of a complementary sensitivity function with respect to a modeling error between the control target and the nominal model, is 1 or substantially 1. The calculator is configured or programmed to execute first calculation processing to calculate the input value. In the first calculation processing, the calculator is configured or programmed to calculate the input value based on a first output value acquired based on a first sensor and indicating an output of the motor, and a second output value acquired based on a second sensor and indicating an output of the decelerator.

A motor device according to an example embodiment of the present disclosure includes the control device and the motor.

An electric power steering device according to an example embodiment of the present disclosure includes the motor device, and a steering mechanism including the input shaft, the output shaft, and the torsion bar.

A control method according to an example embodiment of the present disclosure is a method of controlling, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator. The control method includes executing a model following control to generate a correction value to correct an input torque to be input to the control target, based on a nominal model based on a configuration of the control target, constraining a transfer function of the control target to a transfer function of the nominal model in a frequency band in which a complementary sensitivity gain is 1 or substantially 1 by the model following control, the complementary sensitivity gain being a gain in the gain characteristic of a complementary sensitivity function with respect to a modeling error between the control target and the nominal model, and executing first calculation processing to calculate an input value to be input to an inverse nominal model that is an inverse model of the nominal model, in the model following control. The first calculation processing includes calculating the input value based on a first output value acquired based on a first sensor and indicating an output of the motor, and a second output value acquired based on a second sensor and indicating an output of the decelerator.

A non-transitory computer-readable medium including a computer program according to an example embodiment of the present disclosure causes a computer to execute the control method described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram schematically illustrating an electric power steering device according to an example embodiment of the present disclosure.

FIG. 2 is a block diagram illustrating a configuration of a control device according to an example embodiment of the present disclosure.

FIG. 3 is a functional block diagram illustrating functions of a processor in the control device according to an example embodiment of the present disclosure.

FIG. 4 is a graph illustrating a gain characteristic of a complementary sensitivity function and a gain characteristic of a reciprocal of a modeling error between a transfer function of a control target and a transfer function of a nominal model according to an example embodiment of the present disclosure.

FIG. 5 is a graph illustrating an example of a relationship between a steering angle and a self-aligning torque.

FIG. 6 is a block diagram illustrating an input unit according to an example embodiment of the present disclosure.

FIG. 7 is a flowchart illustrating a portion of processing by a calculator according to an example embodiment of the present disclosure.

FIG. 8 is a block diagram illustrating a function of a calculator when first calculation processing is executed according to an example embodiment of the present disclosure.

FIG. 9 is a block diagram illustrating a function of a calculator when second calculation processing is executed according to an example embodiment of the present disclosure.

FIG. 10 is a graph illustrating an example of a gain of a high-frequency output value and a gain of a low-frequency output value according to an example embodiment of the present disclosure.

### DETAILED DESCRIPTION

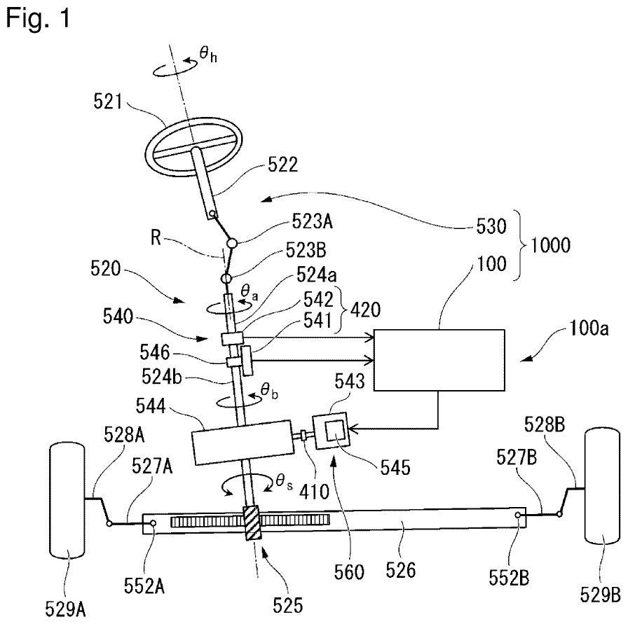

An electric power steering device 1000 of the present example embodiment illustrated in FIG. 1 is mounted on a vehicle. As illustrated in FIG. 1, the electric power steering device 1000 includes a steering mechanism 530 and a control device 100. The steering mechanism 530 includes a steering mechanism unit 520 and an auxiliary mechanism unit 540. The electric power steering device 1000 controls the auxiliary mechanism unit 540 by the control device 100 to generate an auxiliary torque that assists a steering torque Tₕ generated in the steering mechanism unit 520 when a driver who drives the vehicle steers a steering wheel 521. The auxiliary torque reduces the burden of the driver's operation when the driver operates the steering wheel 521. The driver of the vehicle is a steering operator who steers the steering wheel 521 of the vehicle.

The steering mechanism unit 520 includes the steering wheel 521, a steering shaft 522, universal joints 523A and 523B, an input shaft 524a, an output shaft 524b, a rack and pinion mechanism 525, a rack shaft 526, right and left ball joints 552A and 552B, tie rods 527A and 527B, knuckles 528A and 528B, and right and left tires 529A and 529B. That is, the steering mechanism 530 includes the steering wheel 521, the steering shaft 522, the universal joints 523A and 523B, the input shaft 524a, the output shaft 524b, the rack and pinion mechanism 525, the rack shaft 526, the right and left ball joints 552A and 552B, the tie rods 527A and 527B, the knuckles 528A and 528B, and the right and left tires 529A and 529B.

The steering shaft 522 is a shaft extending from the steering wheel 521 steered by a steering operator. One end portion of the input shaft 524a is connected to an end portion of the steering shaft 522 on a side opposite to a side connected to the steering wheel 521 via the universal joints 523A and 523B. As a result, the steering wheel 521 is connected to the input shaft 524a via the universal joints 523A and 523B and the steering shaft 522. The output shaft 524b is connected to the input shaft 524a via a torsion bar 546 described later. More specifically, one end portion of the output shaft 524b is connected to another end portion of the input shaft 524a via the torsion bar 546. The other end portion of the output shaft 524b is connected to the rack shaft 526 via the rack and pinion mechanism 525.

The input shaft 524a and the output shaft 524b are coaxially arranged. The input shaft 524a and the output shaft 524b are rotatable about the same central axis. The input shaft 524a and the output shaft 524b are relatively rotatable with respect to each other in a range in which the torsion bar 546 described later can be twisted.

The auxiliary mechanism unit 540 includes a motor 543, a decelerator 544, an inverter 545, a torsion bar 546, a first sensor 410, and a second sensor 420. That is, the steering mechanism 530 includes the motor 543, the decelerator 544, the inverter 545, the torsion bar 546, the first sensor 410, and the second sensor 420. The torsion bar 546 connects the input shaft 524a and the output shaft 524b. The torsion bar 546 is arranged coaxially with the input shaft 524a and the output shaft 524b. In the description below, a virtual axis passing through a common central axis of the input shaft 524a, the output shaft 524b, and the torsion bar 546 is referred to as a rotation axis R. The torsion bar 546 can be twisted around the rotation axis R.

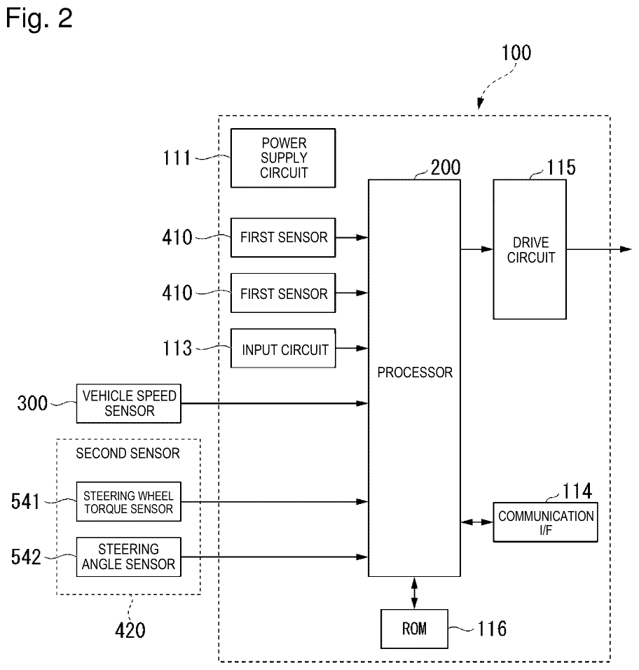

The first sensor 410 detects a rotation angle θₘ of the rotor of the motor 543, and outputs the rotation angle θₘ to a processor 200 described later. The first sensor 410 may be a resolver, a Hall element such as a Hall IC, or an MR sensor having a magnetoresistive element. The control device 100 acquires a first output value θ₁ as a value indicating the rotation angle θₘ of the motor 543 based on the first sensor 410. The rotation angle θₘ is an output of the motor 543. That is, the first output value θ₁ indicates an output of the motor 543. As illustrated in FIG. 2, in the present example embodiment, two first sensors 410 are provided. Note that the two first sensors 410 may be collectively provided as one sensor device, or may be provided as separate sensor devices. When the two first sensors 410 are collectively provided as one sensor device, the sensor device outputs two first output values θ₁ each indicating the rotation angle θₘ of the motor 543.

In the present example embodiment, the second sensor 420 includes a steering torque sensor 541 and a steering angle sensor 542. The steering torque sensor 541 detects the steering torque Tₕ in the steering mechanism unit 520 by detecting the amount of torsion around the rotation axis R of the torsion bar 546. The steering torque Tₕ is a torsion bar torque generated in the torsion bar 546, and is torsional moment around the rotation axis R. The steering angle sensor 542 can detect a rotation angle θₐ around the rotation axis R of the input shaft 524a. The rotation angle θₐ of the input shaft 524a is equal to a steering angle θₙ of the steering wheel 521. That is, the steering angle sensor 542 can detect the steering angle θₙ of the steering wheel 521 by detecting the rotation angle θₐ of the input shaft 524a. A rotation angle θ_{b} of the output shaft 524b can be detected based on the steering torque sensor 541 and the steering angle sensor 542. The rotation angle θ_{b} of the output shaft 524b is a steering angle θₛ.

In the present example embodiment, the control device 100 acquires a second output value θ₂ as a value indicating the steering angle θs based on the second sensor 420. In the present example embodiment, the steering angle θₛ is an output of the decelerator 544. That is, the second output value θ₂ indicates an output of the decelerator 544. Note that the second sensor 420 may be a sensor configured of only one sensor that directly detects the rotation angle θ_{b} of the output shaft 524b.

The inverter 545 illustrated in FIG. 1 converts DC power into three-phase AC power having U-phase, V-phase, and W-phase pseudo sine waves in accordance with a motor driving signal input from the control device 100, and supplies the power to the motor 543. The motor 543 is connected to the output shaft 524b via the decelerator 544. The three-phase AC power is supplied from the inverter 545 to the motor 543. The motor 543 is, for example, an interior permanent magnet synchronous motor (IPMSM), a surface mounted permanent magnet synchronous motor (SPMSM), a switched reluctance motor (SRM), or the like. When the three-phase AC power is supplied from the inverter 545, the motor 543 generates an auxiliary torque according to the steering torque Tₕ. The motor 543 transmits the generated auxiliary torque to the output shaft 524b via the decelerator 544.

The control device 100 controls a portion including at least the motor 543 and the decelerator 544 in the steering mechanism 530 mounted on the vehicle, as the control target 560. In the present example embodiment, the control target 560 includes the steering mechanism unit 520, the torsion bar 546, the motor 543, and the decelerator 544. Since the control target 560 includes the input shaft 524a and the output shaft 524b that can rotate relative to each other via the torsion bar 546, the motion of the control target 560 cannot be described only by a simple equation of motion of the one-inertia system. The control target 560 changes between the one-inertia system and the two-inertia system depending on the strength with which the steering operator grips the steering wheel 521. The stronger the steering operator grips the steering wheel 521, the closer the control target 560 is to the one-inertia system. The weaker the steering operator grips the steering wheel 521, the closer the control target 560 is to the two-inertia system. As described above, the control target 560 includes the two-inertia system.

The control device 100 is electrically connected to the inverter 545. The control device 100 generates a motor driving signal based on the detection signals detected by the steering torque sensor 541, the steering angle sensor 542, a vehicle speed sensor 300 mounted on a vehicle, and the like, and outputs the motor driving signals to the inverter 545. The control device 100 controls the control target 560 by controlling the rotation of the motor 543 via the inverter 545. More specifically, the control device 100 controls the switching operation of a plurality of switching elements included in the inverter 545. Specifically, the control device 100 generates a control signal for controlling the switching operation of each switching element and outputs the control signal to the inverter 545. Each switching element is, for example, a metal-oxide-semiconductor field-effect transistor (MOSFET). In the description below, a control signal for controlling the switching operation of each switching element is referred to as a “gate control signal”.

The control device 100 generates a torque command value based on the steering torque Tₕ and the like, and controls the torque of the motor 543 and the rotation speed of the motor 543 by means of, for example, vector control. The vector control is a method in which current flowing through the motor 543 is separated into a current component that contributes to generation of a torque and a current component that contributes to generation of a magnetic flux, and the current components orthogonal to each other are independently controlled. The control device 100 may perform not only the vector control but also another piece of closed-loop control. A rotational speed of the motor 543 is expressed by, for example, a rotational speed [revolutions per minute (rpm)] at which a rotor rotates in one minute, a rotational speed [revolutions per second (rps)] at which a rotor rotates in one second, or the like.

Note that a value of the steering torque Tₕ may be directly input to the control device 100 from the steering torque sensor 541, or the control device 100 may calculate a value of the steering torque Tₕ from an output value of the steering torque sensor 541. A value of the steering angle θₙ of the steering wheel 521 may be directly input to the control device 100 from the steering angle sensor 542, or the control device 100 may calculate a value of the steering angle θₙ from an output value of the steering angle sensor 542.

In the present example embodiment, the electric power steering device 1000 includes a motor device 100a. The motor device 100a includes the control device 100, the motor 543, and the inverter 545. The motor device 100a can be manufactured and sold independently of a portion other than the motor device 100a of the electric power steering device 1000. In addition, the control device 100 can be manufactured and sold as a control device for controlling the electric power steering device 1000 independently of a portion other than the control device 100 of the motor device 100a.

FIG. 2 illustrates a typical example of the configuration of the control device 100 according to the present example embodiment. The control device 100 includes a power supply circuit 111, two first sensors 410, an input circuit 113, a communication I/F 114, a driving circuit 115, a ROM 116, and a processor 200, for example. The control device 100 may be realized as a printed circuit board (PCB) on which these electronic components are mounted.

In the processor 200, the vehicle speed sensor 300, the steering torque sensor 541, and the steering angle sensor 542 mounted on the vehicle are connected to the processor 200 such that signals can be input to the processor 200. The processor 200 receives the vehicle speed from the vehicle speed sensor 300. The processor 200 receives the steering torque Tₕ from the steering torque sensor 541. The processor 200 receives the steering angle θₕ from the steering angle sensor 542.

The processor 200 is a semiconductor integrated circuit, and is also referred to as a central processing unit (CPU) or a microprocessor. The processor 200 sequentially executes computer programs which are stored in the ROM 116 and describe commands for controlling motor driving, and realizes desired processing. In addition to the processor 200 or instead of the processor 200, the control device 100 may include a field programmable gate array (FPGA) equipped with a CPU, a graphics processing unit (GPU), an application specific integrated circuit (ASIC), an application specific standard product (ASSP), or a combination of two or more circuits selected from these circuits. The processor 200 sets a current command value according to the actual current value, the rotation angle of the rotor of the motor 543, and the like, generates a pulse width modulation (PWM) signal, and outputs the PWM signal to the driving circuit 115.

The power supply circuit 111 is connected to an external power supply (not illustrated). The power supply circuit 111 generates DC voltage necessary for each unit of the control device 100. The DC voltage generated in the power supply circuit 111 is, for example, 3 V or 5 V.

The processor 200 can calculate an angular velocity ω [rad/s] of the motor 543 based on an electrical angle of the motor 543 obtained based on the first sensor 410. Note that the control device 100 may include, instead of the first sensor 410, a speed sensor capable of detecting the rotational angular velocity of the motor 543 and an acceleration sensor capable of detecting the rotational angular acceleration of the motor 543.

A motor current value detected by a current sensor (not illustrated) is input to the input circuit 113. In the description below, a motor current value detected by a current sensor (not illustrated) is referred to as an “actual current value”. The input circuit 113 converts the level of an input actual current value into an input level of the processor 200 as necessary, and outputs the actual current value to the processor 200. A typical example of the input circuit 113 is an analog-digital conversion circuit.

The communication I/F 114 is an input and output interface for transmitting and receiving data in conformity with an in-vehicle controller area network (CAN), for example.

The driving circuit 115 is typically a gate driver or a pre-driver. The driving circuit 115 generates a gate control signal in accordance with a PWM signal, and gives the gate control signal to gates of a plurality of switching elements included in the inverter 545. For example, when the motor 543 to be driven is a motor that can be driven at a low voltage, the driving circuit 115 as a gate driver is not necessarily required in some cases. In that case, the function of the gate driver in the driving circuit 115 may be implemented in the processor 200.

The ROM 116 is electrically connected to the processor 200. The ROM 116 is a writable memory, a rewritable memory, or a read-only memory, for example. Examples of the writable memory include a programmable read only memory (PROM). Examples of the rewritable memory include a flash memory, an electrically erasable programmable read only memory (EEPROM), and the like. The ROM 116 stores therein a control program including commands for causing the processor 200 to control motor driving. For example, the control program stored in the ROM 116 is once developed in a RAM (not illustrated) at the time of booting.

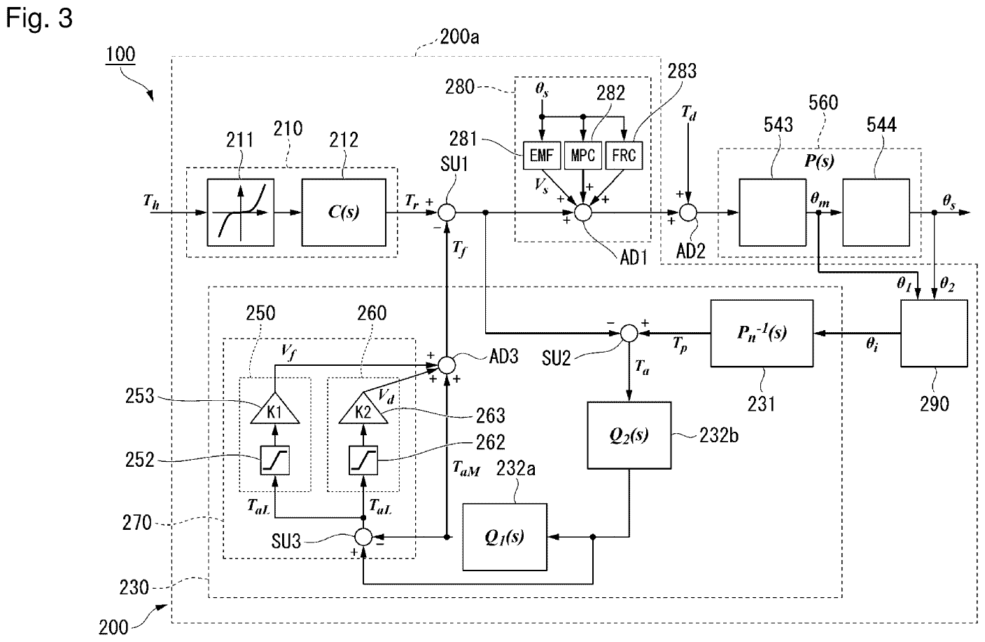

FIG. 3 illustrates an example of functional blocks of the processor 200 according to the present example embodiment. The processor 200, which is a computer, sequentially executes processing or tasks necessary for controlling the motor 543 using each functional block. Each functional block of the processor 200 illustrated in FIG. 3 may be implemented in the processor 200 as software such as firmware, may be implemented in the processor 200 as hardware, or may be implemented in the processor 200 as software and hardware. The processing of each functional block in the processor 200 is typically described in a computer program in units of software modules and stored in the ROM 116. However, in a case where an FPGA or the like is used, all or a portion of the functional blocks may be implemented as a hardware accelerator. A method of controlling the control target 560 according to the present example embodiment is executed by the processor 200, which is a computer, executing a program stored in the control device 100. That is, the program of the present example embodiment stored in the control device 100 causes the processor 200, which is a computer, to execute the method of controlling the control target 560 of the present example embodiment.

The processor 200 includes a controller 200a. The controller 200a includes an assist controller 210, a model following controller 230, a state feedback unit 280, an input unit 290, and a subtractor SU1. That is, the control device 100 includes the assist controller 210, the model following controller 230, the state feedback unit 280, the input unit 290, and the subtractor SU1. In other words, functions corresponding to the assist controller 210, the model following controller 230, the state feedback unit 280, the input unit 290, and the subtractor SU1, respectively, are implemented in the processor 200 of the control device 100.

The steering torque Tₕ detected by the steering torque sensor 541 is input to the assist controller 210. The assist controller 210 generates the input torque Tᵣ to be input to the control target 560 based on the steering torque Tₕ, that is, the torsion bar torque generated in the torsion bar 546. In other words, the method of controlling the control target 560 includes generating the input torque Tᵣ to be input to the control target 560 based on the steering torque Tₕ. The input torque Tᵣ is a target torque of the motor 543 and is a torque command value. The assist controller 210 generates the input torque Tᵣ and controls the torque of the motor 543 to thereby control the reaction force transmitted from the steering wheel 521 to the steering operator. The assist controller 210 generates the input torque Tᵣ by applying phase compensation to the steering torque Tₕ when the steering frequency or the steering speed is within a predetermined range. The steering frequency is a frequency of the steering angle that changes based on the operation of the steering wheel 521 by the steering operator. The steering speed is a speed of the steering angle that changes based on the operation of the steering wheel 521 by the steering operator. The assist controller 210 illustrated in FIG. 3 includes a base assist calculator 211 and a phase compensator 212.

The base assist calculator 211 acquires the steering torque Tₕ and the vehicle speed. The vehicle speed is a speed of the vehicle. The base assist calculator 211 generates a base assist torque based on the steering torque Tₕ and the vehicle speed. For example, the base assist calculator 211 includes a look-up table (LUT) in which a relationship among the steering torque Tₕ, the vehicle speed, and the base assist torque is defined. The base assist calculator 211 can determine the base assist torque having a correspondence relationship based on the steering torque Tₕ and the vehicle speed with reference to the look-up table. The base assist calculator 211 can determine a base assist gain based on the inclination defined by a ratio of a change amount of the base assist torque to a fluctuation amount of the steering torque Tₕ.

The phase compensator 212 in the present example embodiment adjusts the base assist gain within a possible range of the steering frequency when the steering operator operates the steering wheel 521, and compensates for the rigidity of the torsion bar 546. The range that a steering frequency can take is, for example, 5 Hz or less. The phase compensator 212 may apply, for example, first-order phase compensation to the steering torque Tₕ, that is, the torsion bar torque, when the steering frequency is 5 Hz or less. The first-order phase compensation is expressed by, for example, a transfer function of Expression (1).

$$\begin{matrix}Expression 1 & \\ C ( s ) = \frac{\frac{1}{2 π {f}_{1}} s + 1}{\frac{1}{2 π {f}_{2}} s + 1} & ( 1 )\end{matrix}$$

In Expression (1), s represents a Laplace transformer, f₁ represents a frequency (Hz) at the zero point of the transfer function, and f₂ represents a frequency (Hz) for determining the pole of the transfer function. A graph in which the gain or loop gain is set as a vertical axis and the logarithm of the frequency is set as a horizontal axis is referred to as a gain diagram. In the gain diagram, the zero point means the intersection of the gain curve and the horizontal axis indicating 0 dB, and the pole means the maximum point of the gain curve. For example, by setting the pole frequency to be higher than the zero point frequency, a phase lead compensation can be applied. The larger the interval between the frequency of the pole and the frequency of the zero point, the larger the phase advance amount.

The phase compensator 212 generates the input torque Tᵣ based on the base assist torque and the base assist gain output from the base assist calculator 211. For example, the phase compensator 212 may be a stabilization compensator and apply stability phase compensation to the base assist torque. The phase compensator 212 may have a second-order or higher transfer function whose frequency characteristic is variable according to the base assist gain. The second-order or higher transfer function is expressed using a responsiveness parameter and a damping parameter. The second-order or higher transfer function can be expressed by, for example, Expression (2). By setting the order number of the transfer function to two, damping can be given to the characteristic of the transfer function. A phase characteristic can be adjusted by changing the damping.

$$\begin{matrix}Expression 2 & \\ C ( s ) = \frac{{s}^{2} + 2 {ζ}_{1} {ω}_{1} s + {ω}_{1}^{2}}{{s}^{2} + 2 {ζ}_{2} {ω}_{2} s + {ω}_{2}^{2}} ( \frac{{ω}_{2}^{2}}{{ω}_{1}^{2}} ) & ( 2 )\end{matrix}$$

In Expression (2), s represents a Laplace transformer, ω₁ represents a frequency at the zero point of the transfer function, ω₂ represents a frequency of a pole of the transfer function, ζ₁ represents a damping ratio of the zero point, and ζ₂ represents a damping ratio of the pole. The pole frequency ω₂ is lower than the zero point frequency ω₁.

The model following controller 230 generates the correction torque T_{f} to correct the input torque Tᵣ based on the nominal model based on the configuration of the control target 560. In the present example embodiment, the correction torque T_{f} is a feedback torque fed back to the input torque Tᵣ. The nominal model is an internal model used as a model that constrains the control target 560 when controlling the control target 560. The nominal model will be described in detail later. The model following controller 230 is a controller configured to perform model following control. The method of controlling the control target 560 includes executing model following control to generate the correction torque T_{f} to correct the input torque Tᵣ based on the nominal model based on the configuration of the control target 560. A specific configuration of the model following controller 230 will be described in detail later.

The subtractor SU1 subtracts the correction torque T_{f} output from the model following controller 230, from the input torque Tᵣ output from the assist controller 210. The output from the subtractor SU1 is input to the adder AD1 and the model following controller 230. The adder AD1 outputs a value obtained by adding the output from the state feedback unit 280 to the output from the subtractor SU1, to the adder AD2. The adder AD2 outputs a value obtained by adding a disturbance torque T_{d} to the output from the adder AD1, to the control target 560.

The disturbance torque T_{d} is a difference between the actual output torque of the motor 543 and the ideal output torque of the motor 543. The disturbance torque T_{d} includes a disturbance torque externally applied to the control target 560. The disturbance torque T_{d} includes, for example, an extra torque generated by friction and backlash due to mechanical elements such as the motor 543 and the decelerator 544, a torque ripple generated in the motor 543, a self-aligning torque T_{SAT}, a disturbance torque that may be generated when traveling on an unpaved rattling road, a gravel road, or the like, and the steering torque Tₕ.

In the present example embodiment, the model following controller 230 generates the correction torque T_{f} based on the input value θᵢ output from the input unit 290, and feeds back the correction torque T_{f} to the input torque Tᵣ. The model following controller 230 includes an inverse nominal model 231, a first filter 232a, a second filter 232b, an assist adjustment unit 270, a subtractor SU2, and an adder AD3. In the present example embodiment, the first filter 232a is a high-pass filter. The first filter 232a has a first cutoff frequency Cf1. The first cutoff frequency Cf1 is, for example, 2 Hz or higher and 10 Hz or lower. In the present example embodiment, the first cutoff frequency Cf1 is higher than 5 Hz and lower than 10 Hz.

In the present example embodiment, the second filter 232b is a low-pass filter. The second filter 232b has a second cutoff frequency Cf2 higher than the first cutoff frequency Cf1. The second cutoff frequency Cf2 is, for example, 3 Hz or higher and 50 Hz or lower. However, an upper limit of the second cutoff frequency Cf2 may be set in a range of about 140 Hz or higher and 200 Hz or lower. The order of the second filter 232b is third order or more. The second filter 232b may include, for example, a plurality of low-pass filters. The first filter 232a and the second filter 232b are coupled in series.

The model following controller 230 is configured such that a transfer function P(s) of the control target 560 is constrained to a transfer function Pₙ(s) of the nominal model in a frequency band in which a complementary sensitivity gain GT that is a gain in the gain characteristic of a complementary sensitivity function T(s) with respect to a modeling error between the control target 560 and the nominal model is substantially 1. In other words, the control method of the present example embodiment includes constraining the transfer function P(s) of the control target 560 to the transfer function Pₙ(s) of the nominal model in the frequency band in which the complementary sensitivity gain GT is substantially 1, by the model following control. “The complementary sensitivity gain GT is substantially 1” includes, for example, the case where the complementary sensitivity gain GT is 0.8 or more and 1.2 or less, in addition to the case where the complementary sensitivity gain GT is 1. The numerical range is, for example, a range in which a gain of a substantial disturbance reduction characteristic can be adjusted to 1 in consideration of positive efficiency and reverse efficiency of a worm gear in the case where the decelerator 544 connected to the motor 543 includes the worm gear. Since efficiency of the worm gear is about 0.8, it is necessary to adjust the gain by ±0.2 with respect to the target value 1.

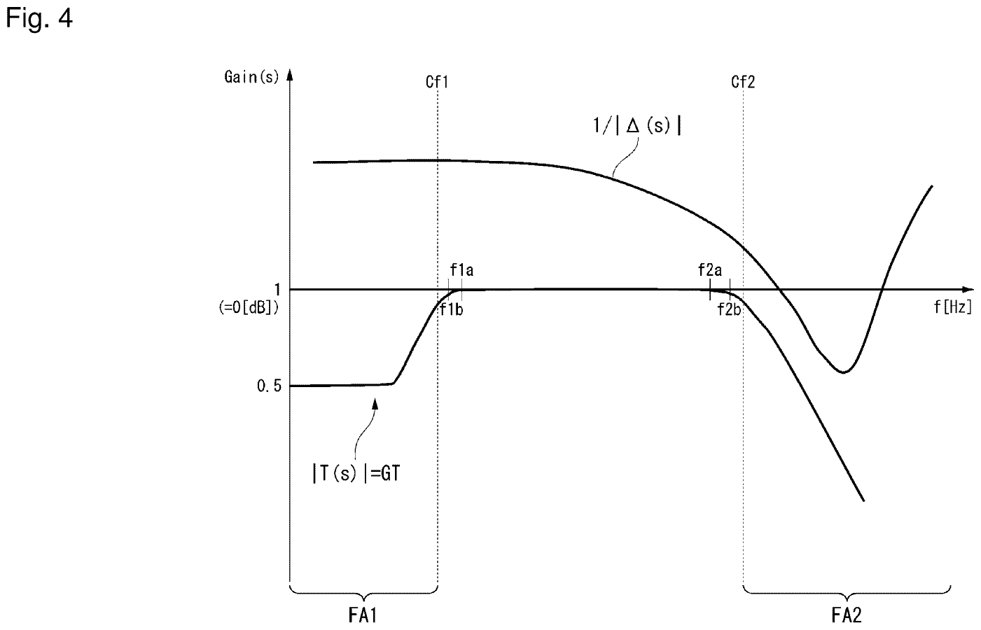

The complementary sensitivity function T(s) is a complementary sensitivity function of an inner loop including the model following controller 230. FIG. 4 illustrates the complementary sensitivity gain GT in the complementary sensitivity function T(s). The complementary sensitivity gain GT is a gain of the complementary sensitivity function T(s) as a transfer function, and is an absolute value of the complementary sensitivity function T(s). In the graph of FIG. 4, the horizontal axis represents the frequency f [Hz], and the vertical axis represents the complementary sensitivity gain GT. As illustrated in FIG. 4, in the complementary sensitivity function T(s), the gain is substantially 0 dB in at least a portion of the frequency band where the frequency f is equal to or higher than the first cut-off frequency Cf1 and equal to or lower than the second cut-off frequency Cf2, that is, the complementary sensitivity gain GT in the transfer function is substantially 1. In the example of FIG. 4, the complementary sensitivity gain GT is 1 in a frequency band that is equal to or higher than the frequency f1a higher than the first cut-off frequency Cf1 and equal to or lower than the frequency f2a lower than the second cut-off frequency Cf2. The frequency f1a is lower than the frequency f2a. In the frequency band of the frequency f1a or higher and the frequency f2a or lower, the complementary sensitivity gain GT may be, for example, a value of 0.95 or larger and smaller than 1. The complementary sensitivity gain GT at the first cutoff frequency Cf1 is smaller than the complementary sensitivity gain GT at the frequency f1a. The complementary sensitivity gain GT at the second cutoff frequency Cf2 is smaller than the complementary sensitivity gain GT at the frequency f2a. In the present example embodiment, the frequency band in which the complementary sensitivity gain GT is substantially 1 is a frequency band of the frequency f1b or higher and the frequency f2b or lower. The frequency f1b is higher than the first cutoff frequency Cf1 and lower than the frequency f1a. The frequency f2b is lower than the second cutoff frequency Cf2 and higher than the frequency f2a. In the frequency band of the frequency f1b or higher and the frequency f2b or lower, the complementary sensitivity gain GT is, for example, 0.8 or larger and 1 or smaller. Note that, in the present description, “a transfer function of a control target is constrained to a transfer function of a nominal model” means that, for example, a control target is controlled such that a transfer function of the control target appears to be a transfer function of a nominal model apparently when an input and output relationship is viewed.

The transfer function P(s) of the control target 560 is a plant characteristic on which the model following control is performed. The transfer function P(s) of the control target 560 is expressed by, for example, Expression (3) below.

$$\begin{matrix}Expression 3 & \\ P ( s ) = \frac{1}{{Js}^{2} + Bs + {K}_{S A T}} & ( 3 )\end{matrix}$$

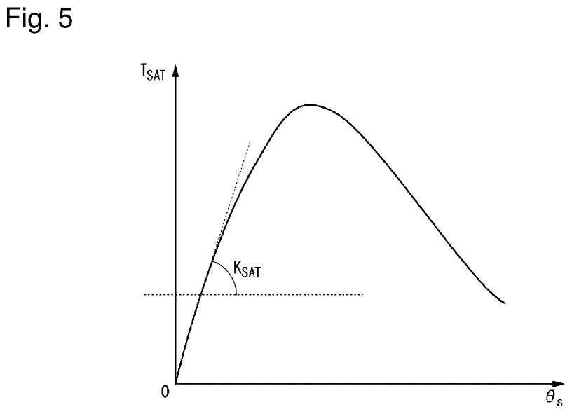

Here, s represents a Laplace transformer, J is a parameter representing the moment of inertia of the steering mechanism unit 520, and B is a parameter representing a viscous friction coefficient of the steering mechanism unit 520. K_{SAT} represents a self-aligning torque gain. The self-aligning torque gain K_{SAT} is an inclination of the self-aligning torque T_{SAT} generated in the tires 529A and 529B of the vehicle with respect to the steering angle θs. FIG. 5 illustrates an example of the relationship between the self-aligning torque T_{SAT} and the steering angle θs. In the graph of FIG. 5, the horizontal axis represents the steering angle θs, the vertical axis represents the self-aligning torque T_{SAT}, and the inclination of the self-aligning torque T_{SAT} with respect to the steering angle θs is the self-aligning torque gain K_{SAT}. The steering angle θs, the self-aligning torque T_{SAT}, and the self-aligning torque gain K_{SAT} satisfy the relationship of dT_{SAT}/dθₛ=K_{SAT}. As illustrated in FIG. 5, for example, the self-aligning torque T_{SAT} becomes larger as the steering angle θs becomes larger up to a certain degree of the steering angle θₛ, and becomes smaller as the steering angle θₛ becomes larger when the steering angle θₛ becomes a certain degree or more.

The inverse nominal model 231 is an inverse model of a predetermined nominal model used to constrain the control target 560. The transfer function Pₙ(s) of the nominal model is expressed by, for example, Expression (4) below. A transfer function Pₙ⁻¹(s) of the inverse nominal model 231 is expressed by, for example, Expression (5) below.

$$\begin{matrix}Expression 4 & \\ {P}_{n} ( s ) = \frac{1}{{J}_{n} {s}^{2} + {B}_{n} s} & ( 4 )\end{matrix}$$

$$\begin{matrix}Expression 5 & \\ {P}_{n}^{- 1} ( s ) = {J}_{n} {s}^{2} + {B}_{n} s & ( 5 )\end{matrix}$$

In Expressions (4) and (5), s represents a Laplace transformer, Jₙ is a parameter representing the inertia moment of the nominal model, and Bₙ is a parameter representing the viscous friction coefficient of the nominal model. Note that the transfer function Pₙ(s) of the nominal model and the transfer function Pₙ⁻¹(s) of the inverse nominal model 231 are not limited to the examples illustrated in Expressions (4) and (5), and are not particularly limited.

As illustrated in FIG. 3, the input value θᵢ, which is an output from the input unit 290, is input to the inverse nominal model 231. That is, in the present example embodiment, the input value θᵢ is input to the model following controller 230. The inverse nominal model 231 outputs a torque Tₚ based on the above Expression (5) and the input value θᵢ input thereto. That is, the model following controller 230 calculates the torque Tₚ using the nominal model based on the output of the input unit 290. The torque Tₚ is equal to the value of the torque input to the nominal model when the output value of the nominal model is the same value as the output value of the control target 560.

The subtractor SU2 subtracts the output from the subtractor SU1 from the output of the inverse nominal model 231 to generate a differential torque Tₐ. The output from the subtractor SU1 is the input torque Tᵣ after the correction torque T_{f} is subtracted. That is, the input torque Tᵣ after the correction torque T_{f} is subtracted is input to the model following controller 230. In the present example embodiment, the subtractor SU2 generates the differential torque Tₐ by subtracting, from the torque Tₚ, the input torque Tᵣ before a state compensation value Vₛ described later is fed back, after the correction torque T_{f} is fed back. The differential torque Tₐ is, for example, an estimated value of the disturbance torque T_{d}. The differential torque Tₐ output from the subtractor SU2 is input to the second filter 232b and subjected to low-pass filter processing, and then input to the first filter 232a and subjected to high-pass filter processing. The differential torque Tₐ subjected to filter processing by the first filter 232a and the second filter 232b is input to the adder AD3. The torque input from the first filter 232a to the adder AD3 is subjected to filter processing by the first filter 232a and the second filter 232b with respect to the differential torque Tₐ output from the subtractor SU2, and a frequency component lower than the first cutoff frequency Cf1 and a frequency component higher than the second cutoff frequency Cf2 are removed. That is, the torque input from the first filter 232a to the adder AD3 is a frequency component T_{aM} equal to or higher than the first cutoff frequency Cf1 and equal to or lower than the second cutoff frequency Cf2 in the differential torque Tₐ output from the subtractor SU2.

The assist adjustment unit 270 generates a compensation value for friction and disturbance and adjusts the differential torque Tₐ. In the present example embodiment, the assist adjustment unit 270 adjusts the frequency component T_{aM} in the differential torque Tₐ. The assist adjustment unit 270 is coupled in parallel to the first filter 232a. The assist adjustment unit 270 includes a friction compensation value calculator 250, a disturbance compensation value calculator 260, and a subtractor SU3.

The subtractor SU3 subtracts an output value from the first filter 232a, from an output value from the second filter 232b. Here, the output value from the second filter 232b is a value obtained by removing a frequency component higher than the second cutoff frequency Cf2 from the differential torque Tₐ, that is, the frequency component T_{aML}. The output value from the first filter 232a is a value obtained by removing a frequency component higher than the second cutoff frequency Cf2 and a frequency component lower than the first cutoff frequency Cf1 from the differential torque Tₐ, that is, the frequency component T_{aM}. Therefore, the value output from the subtractor SU3 is the frequency component T_{aL} lower than the first cutoff frequency Cf1 in the differential torque Tₐ. The output of the subtractor SU3 is input to the friction compensation value calculator 250 and the disturbance compensation value calculator 260. The frequency component T_{aL} includes a frictional force, the self-aligning torque T_{SAT}, the disturbance torque caused by backlash of the control target 560, a torque ripple generated in the control target 560, and the like.

The friction compensation value calculator 250 calculates the friction compensation value V_{f} that compensates at least a portion of the frictional force generated in control target 560, based on the differential torque Tₐ. As described above, the value from the subtractor SU3 input to the friction compensation value calculator 250 is the frequency component T_{aL} lower than the first cutoff frequency Cf1 in the differential torque Tₐ. Therefore, in the present example embodiment, the friction compensation value calculator 250 calculates the friction compensation value V_{f} based on the component having a frequency lower than the first cutoff frequency Cf1 in the differential torque Tₐ.

The friction compensation value calculator 250 includes a limiter 252 and a gain adjuster 253. The limiter 252 limits the output value from the subtractor SU3. The limiter 252 clips the input value to the upper or lower threshold when the input value exceeds the upper or lower threshold. The gain adjuster 253 multiplies a gain K1 by an output value from the limiter 252. The friction compensation value calculator 250 calculates the friction compensation value V_{f} by applying a limit by the limiter 252 and the gain K1 to a component of a frequency lower than the first cutoff frequency Cf1 in the differential torque Tₐ. The threshold of the limiter 252 and the value of the gain K1 are determined in advance based on, for example, the frictional force actually generated in the control target 560.

The friction compensation value V_{f} output from the friction compensation value calculator 250 is a value that compensates for at least a portion of the frictional force component included in the frequency component T_{aL} of the differential torque Tₐ. In general, since appropriate friction is required for the control target 560, the friction compensation value calculator 250 calculates a value smaller than the frictional force actually generated in the control target 560 as the friction compensation value V_{f}. This makes it possible to achieve highly accurate friction compensation while maintaining an appropriate frictional force on the control target 560. A target of friction compensation using the friction compensation value V_{f} is, for example, friction of the motor 543, friction of the decelerator 544, a difference between right and left in friction of the decelerator 544, and the like.

The vehicle equipped with the electric power steering device 1000 can travel according to a travel mode having an automatic driving mode and a manual driving mode. In this case, the gain K1 of the gain adjuster 253 may be switched according to the travel mode. The greater the gain K1 of the gain adjuster 253, the greater the degree of friction reduction. The gain K1 in the automatic driving mode is preferably larger than the gain K1 set in the manual driving mode. As a result, it is possible to apply optimum friction compensation to an automatic driving mode in which a reduction in friction is more required.

The disturbance compensation value calculator 260 calculates a disturbance compensation value V_{d} for compensating at least a portion of the self-aligning torque T_{SAT} generated in the control target 560. In the present example embodiment, the disturbance compensation value V_{d} includes a compensation value for compensating at least a portion of the frictional force generated in the control target 560, the disturbance torque caused by the backlash generated in the control target 560, and the torque ripple generated in the control target 560. The disturbance compensation value calculator 260 calculates the disturbance compensation value V_{d} based on the differential torque Tₐ that is a difference between the torque Tₚ output from the inverse nominal model 231 and the input torque Tᵣ. That is, the disturbance compensation value calculator 260 calculates the disturbance compensation value V_{d} based on the differential torque Tₐ that is a difference between the torque Tₚ calculated using the nominal model based on the output of the control target 560 and the input torque Tᵣ. As described above, the value from the subtractor SU3 input to the disturbance compensation value calculator 260 is a frequency component lower than the first cutoff frequency Cf1 in the differential torque Tₐ. Therefore, in the present example embodiment, the disturbance compensation value calculator 260 calculates the disturbance compensation value V_{d} based on a component having a frequency lower than the first cutoff frequency Cf1 in the differential torque Tₐ.

The disturbance compensation value calculator 260 includes a limiter 262 and a gain adjuster 263. The limiter 262 limits the output value from the subtractor SU3. The limiter 262 clips the input value to the upper or lower threshold when the input value exceeds the upper or lower threshold. The threshold of the limiter 262 is different from the threshold of the limiter 252, for example. The gain adjuster 263 multiplies a gain K2 by an output value from the limiter 262. The maximum value of the gain K2 of the gain adjuster 263 is determined under the condition that the transfer function P(s) of the control target 560 is constrained to the transfer function Pₙ(s) of the nominal model. The value of the gain K2 is different from the value of the gain K1, for example. The value of the gain K2 is, for example, about 0.1 or larger and 0.8 or smaller. The gain K2 of the gain adjuster 263 may be switched according to the travel mode of the vehicle.

The disturbance compensation value V_{d} is a value that compensates for at least a portion of a self-aligning torque component included in the frequency component T_{aL} of the differential torque Tₐ. For example, the disturbance compensation value calculator 260 calculates a value corresponding to about half of the self-aligning torque T_{SAT} actually generated in the control target 560, as the disturbance compensation value V_{d}. The self-aligning torque T_{SAT} actually generated in the control target 560 is experimentally obtained in advance for each frequency, for example. The threshold of the limiter 262 of the disturbance compensation value calculator 260 and the value of the gain K2 are adjusted to values at which the disturbance compensation value V_{d} is calculated as a value about 0.1 times or more and 0.8 times or less the magnitude of the self-aligning torque T_{SAT} obtained in advance. The disturbance compensation value V_{d} calculated by the disturbance compensation value calculator 260 is a value different from the friction compensation value V_{f} calculated by the friction compensation value calculator 250.

Here, the frequency component T_{aL} of the differential torque Tₐ includes a frictional force generated in the control target 560, the self-aligning torque T_{SAT} generated in the control target 560, a disturbance torque caused by backlash generated in the control target 560, and a torque ripple generated in the control target 560. For this reason, the friction compensation value V_{f} obtained by processing the frequency component T_{aL} by the limiter 252 and the gain adjuster 253 also includes a compensation value for compensating at least a portion of the disturbance other than the frictional force, that is, the self-aligning torque T_{SAT} generated in the control target 560, the disturbance torque caused by backlash generated in the control target 560, and the torque ripple generated in the control target 560. In addition, the disturbance compensation value V_{d} obtained by processing the frequency component T_{aL} by the limiter 262 and the gain adjuster 263 also includes a compensation value for compensating at least a portion of the disturbance other than the self-aligning torque T_{SAT}, that is, the frictional force generated in the control target 560, the disturbance torque caused by backlash generated in the control target 560, and the torque ripple generated in the control target 560.

In order to apply friction compensation and disturbance compensation performed in the assist adjustment unit 270 to the correction torque T_{f} used for model following control in the model following controller 230, it is necessary to pay attention to a stability condition of the model following control. This condition is that the gain in the gain characteristic of the transfer function of the assist adjustment unit 270 constrained to the characteristic considering stability does not exceed 1 according to the small gain theorem described later. This is derived from the design condition of the second filter 232b. In the present example embodiment, the subtractor SU3 is provided in the preceding stage of the limiters 252 and 262 so that the values of the gains K1 and K2 in the gain adjusters 253 and 263 are set to 1 at the maximum and the gain in the gain characteristic becomes 1 under this condition, and subtraction processing is applied. In other words, the assist adjustment unit 270 behaves as a low-pass filter having a transfer function of 1−Q₁(s). Q₁(s) is a transfer function of the first filter 232a that is a high-pass filter. The assist adjustment unit 270 performs low-pass filter processing having a transfer function of 1−Q₁(s) on the torque output from the second filter 232b, and adjusts the value applied with the processing in each of the friction compensation value calculator 250 and the disturbance compensation value calculator 260 and outputs the value.

The adder AD3 adds an output value from the assist adjustment unit 270 to an output value from the first filter 232a. That is, the adder AD3 adds the friction compensation value V_{f} and the disturbance compensation value V_{d} to the frequency component T_{aM}. The adder AD3 outputs the correction torque T_{f} calculated by adding the frequency component T_{aM}, the friction compensation value V_{f}, and the disturbance compensation value V_{d}. The correction torque T_{f} output from the adder AD3 is fed back to the input of the control target 560, that is, the input torque Tᵣ. As described above, in the present example embodiment, the model following controller 230 generates the correction torque T_{f} by adding the friction compensation value V_{f} and the disturbance compensation value V_{d} to the differential torque Tₐ from which a frequency component lower than the first cutoff frequency Cf1 is removed by the first filter 232a which is a high-pass filter, that is, the frequency component T_{aM}.

The state feedback unit 280 illustrated in FIG. 3 feeds back the state compensation value Vₛ to the input torque Tᵣ based on the output of the control target 560 so that the apparent transfer function of the control target 560 approaches the transfer function Pₙ(s) of the nominal model. The apparent transfer function of the control target 560 is, for example, a transfer function of one portion in a case where a portion located inside a feedback loop formed by the model following controller 230 is regarded as the one portion. Specifically, in the present example embodiment, the apparent transfer function of the control target 560 is a transfer function of the entire portion from the subtractor SU1 to the output of the control target 560, and is a transfer function of a portion combining the state feedback unit 280 and the control target 560. In the present example embodiment, the state feedback unit 280 feeds back the state compensation value Vₛ to the input torque Tᵣ after being corrected by the correction torque T_{f} and before being input to the control target 560.

The state compensation value Vₛ includes a compensation value that compensates at least a portion of the inertial force generated in the control target 560, the viscous force generated in the control target 560, and the frictional force generated in the control target 560. More specifically, the state compensation value Vₛ includes a compensation value that compensates at least a portion of the inertial force generated in the motor 543, the viscous force generated in the motor 543, and the frictional force generated in the motor 543. In the present example embodiment, the state compensation value Vₛ is a compensation value including the inertial force generated in the motor 543, the viscous force generated in the motor 543, and the frictional force generated in the motor 543.

The state feedback unit 280 includes an inertia compensator 281, a viscosity compensator 282, and a friction compensator 283. The inertia compensator 281 calculates a compensation value for compensating at least a portion of the inertial force generated in the motor 543 based on the steering angle θₛ. The viscosity compensator 282 calculates a compensation value for compensating at least a portion of the viscous force generated in the motor 543 based on the steering angle θₛ. The friction compensator 283 calculates a compensation value for compensating at least a portion of the frictional force generated in the motor 543 based on the steering angle θₛ. In the present example embodiment, the state compensation value Vₛ includes a compensation value calculated by the inertia compensator 281, a compensation value calculated by the viscosity compensator 282, and a compensation value calculated by the friction compensator 283. The compensation value calculated by the inertia compensator 281, the compensation value calculated by the viscosity compensator 282, and the compensation value calculated by the friction compensator 283 are output to the adder AD1 and added to the input torque Tᵣ having been corrected by the correction torque T_{f}.

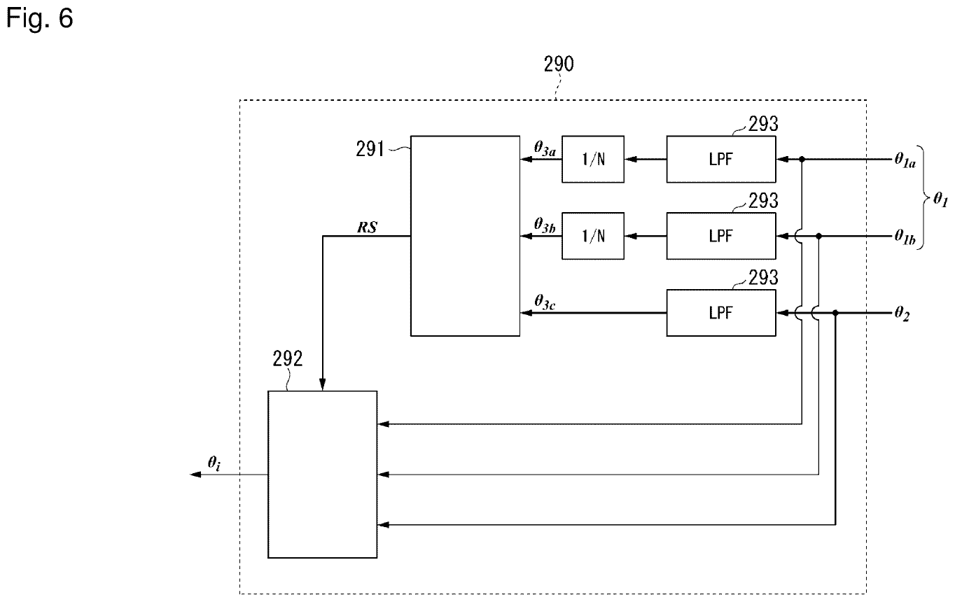

The input unit 290 outputs the input value θᵢ to be input to the model following controller 230 based on the output from the control target 560. The output from the control target 560 is a value detected using various sensors. In the present example embodiment, the first output value θ₁ acquired based on the first sensor 410 and the second output value θ₂ acquired based on the second sensor 420 are input to the input unit 290. As illustrated in FIG. 6, in the present example embodiment, two values, that is, a first output value θ₁ₐ and a first output value θ_{1b}, are input to the input unit 290 as the first output value θ₁. The first output value θ₁ₐ is a first output value θ₁ acquired based on one of the two first sensors 410. The first output value θ_{1b} is a first output value θ₁ acquired based on the other of the two first sensors 410.

The input unit 290 includes an abnormality determiner 291, a calculator 292, and a low-pass filter unit 293. That is, the control device 100 includes the abnormality determiner 291, the calculator 292, and the low-pass filter unit 293. In the present example embodiment, the low-pass filter unit 293 is provided for each output value input to the input unit 290. In the present example embodiment, the input unit 290 includes three low-pass filter units 293. The cutoff frequencies of the three low-pass filter units 293 are, for example, 20 Hz or more and 30 Hz or less. In the present example embodiment, the cutoff frequencies of the three low-pass filter units 293 are the same. Note that the cutoff frequencies of the three low-pass filter units 293 may be different from each other.

The three low-pass filter units 293 each perform low-pass filter processing on the three output values input to the input unit 290. The first output value θ₁ₐ subjected to the low-pass filter processing by the low-pass filter unit 293 is divided by the reduction ratio N of the decelerator 544 to become a value θ₃ₐ, and then is input to the abnormality determiner 291. The first output value θ_{1b} subjected to the low-pass filter processing by the low-pass filter unit 293 is divided by the reduction ratio N of the decelerator 544 to become a value θ_{3b}, and then is input to the abnormality determiner 291. The reduction ratio N is a value obtained by dividing the rotational angular velocity of the motor 543 by the rotational angular velocity of the output of the decelerator 544. The reduction ratio N, the rotation angle θₘ of the motor 543, and the steering angle θₛ satisfy a relationship of N=θₘ/θₛ. The second output value θ₂ subjected to the low-pass filter processing by the low-pass filter unit 293 is input to the abnormality determiner 291 as a value θ_{3c}. As described above, three values θ₃ₐ, θ_{3b}, and θ_{3c} including two values obtained by dividing the two first output values θ₁ₐ and θ_{1b} by the reduction ratio N of the decelerator 544 and one second output value θ₂ are input to the abnormality determiner 291. In the present example embodiment, the three values θ₃ₐ, θ_{3b}, and θ_{3c} input to the abnormality determiner 291 are values subjected to the low-pass filter processing.

The abnormality determiner 291 performs abnormality determination processing to determine whether an abnormality has occurred in the two first sensors 410 and the one second sensor 420, based on the two first output values θ₁ₐ and θ_{1b} acquired based on the two first sensors 410 and the one second output value θ₂ acquired based on the one second sensor 420. That is, the control method of controlling the control target 560 includes abnormality determination processing to determine whether or not an abnormality has occurred in the two first sensors 410 and the one second sensor 420, based on the two first output values θ₁ₐ and θ_{1b} and the one second output value θ₂. The abnormality determiner 291 compares the three values θ₃ₐ, θ_{3b}, and θ_{3c} with each other. When one of the three values θ₃ₐ, θ_{3b}, and θ_{3c} is different from the other two values by a predetermined threshold or more, the abnormality determiner 291 determines that an abnormality has occurred in a sensor used to acquire the one value among the three sensors including the two first sensors 410 and the one second sensor 420. The predetermined threshold is, for example, greater than or equal to a maximum value assumed as a variation in output values acquired based on the respective sensors in a case where the sensors are normal. For example, when each sensor is normal, the predetermined threshold is equal to or greater than a maximum value of a value assumed as an error between the values θ₃ₐ and θ_{3b} acquired based on the first output values θ₁ₐ and θ_{1b} and the value θ_{3c} acquired based on the second output value θ₂. If the difference between the three values θ₃ₐ, θ_{3b}, and θ_{3c} is smaller than the predetermined threshold value, the abnormality determiner 291 determines that the three values θ₃ₐ, θ_{3b}, and θ_{3c} are substantially the same and that the sensors are normal.

In a case where the difference between the two values θ_{3b} and θ_{3c} is less than the predetermined threshold, and at least one of the difference between the value θ₃ₐ and the value θ_{3b} and the difference between the value θ₃ₐ and the value θ_{3c} is equal to or greater than the predetermined threshold, the abnormality determiner 291 determines that an abnormality has occurred in one of the first sensors 410 used to acquire the value θ₃a. In a case where the difference between the two values θ₃ₐ and θ_{3c} is less than the predetermined threshold, and at least one of the difference between the value θ_{3b} and the value θ₃ₐ and the difference between the value θ_{3b} and the value θ_{3c} is equal to or greater than the predetermined threshold, the abnormality determiner 291 determines that an abnormality has occurred in the other first sensor 410 used to acquire the value θ_{3b}. In a case where the difference between the two values θ₃a and θ_{3b} is less than the predetermined threshold value, and at least one of the difference between the value θ₃c and the value θ₃a and the difference between the value θ_{3c} and the value θ_{3b} is equal to or greater than the predetermined threshold value, the abnormality determiner 291 determines that an abnormality has occurred in the second sensor 420 used to acquire the value θ_{3c}. The abnormality determiner 291 outputs a signal RS indicating the determination result of determining the three values θ₃ₐ, θ_{3b}, and θ_{3c} to the calculator 292.

Two first output values θ₁ₐ and θ_{1b}, one second output value θ₂, and the signal RS are input to the calculator 292. The calculator 292 calculates the input value θᵢ based on the input output values and the signal RS. The calculator 292 can execute first calculation processing CP1 and second calculation processing CP2. That is, the control method of controlling the control target 560 includes executing the first calculation processing CP1 and executing the second calculation processing CP2. The first calculation processing CP1 and the second calculation processing CP2 are processing to calculate the input value θᵢ.

When the abnormality determiner 291 determines that no abnormality has occurred in at least one of the two first sensors 410 and the second sensor 420, the calculator 292 calculates the input value θᵢ by the first calculation processing CP1. When the abnormality determiner 291 determines that no abnormality has occurred in at least one of the two first sensors 410 and an abnormality has occurred in the second sensor 420, the calculator 292 calculates the input value θᵢ by the second calculation processing CP2. That is, the control method of controlling the control target 560 includes: calculating the input value θᵢ by the first calculation processing CP1 when it is determined in the abnormality determination processing that no abnormality has occurred in at least one of the two first sensors 410 and the second sensor 420; and calculating the input value θᵢ by the second calculation processing CP2 when it is determined in the abnormality determination processing that no abnormality has occurred in at least one of the two first sensors 410 and it is determined that an abnormality has occurred in the second sensor 420.

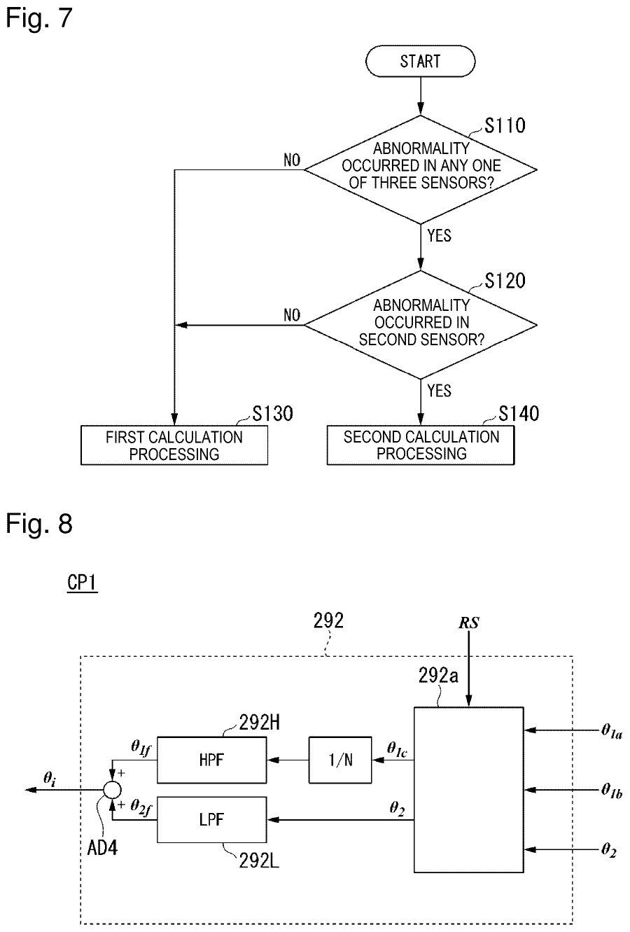

For example, the calculator 292 determines which one of the first calculation processing CP1 and the second calculation processing CP2 is executed along the flowchart illustrated in FIG. 7. Note that FIG. 7 is a flowchart illustrating an example of a case where the abnormality determiner 291 determines that no abnormality has occurred in at least two or more sensors among the three sensors, that is, the two first sensors 410 and the one second sensor 420. For example, when the abnormality determiner 291 determines that an abnormality has occurred in two or more sensors, the calculator 292 does not execute either the first calculation processing CP1 or the second calculation processing CP2 and stops the assist control by the electric power steering device 1000.

As illustrated in FIG. 7, the calculator 292 determines whether or not an abnormality has occurred in any one of the three sensors (step S110). In step S110, the calculator 292 determines whether or not an abnormality has occurred in any one of the three sensors based on the signal RS input from the abnormality determiner 291. When determining in step S110 that no abnormality has occurred in any of the three sensors (step S110: NO), the calculator 292 executes the first calculation processing CP1 (step S130). On the other hand, when determining in step S110 that an abnormality has occurred in any one of the three sensors (step S110: YES), the calculator 292 determines whether or not the sensor in which the abnormality has occurred is the second sensor 420 (step S120). In step S120, the calculator 292 determines whether or not the sensor in which the abnormality occurs is the second sensor 420 based on the signal RS. When determining in step S120 that the sensor in which the abnormality occurs is one of the two first sensors 410 (step S120: NO), the calculator 292 executes the first calculation processing CP1 (step S130). On the other hand, when determining in step S120 that the sensor in which the abnormality occurs is the second sensor 420 (step S120: YES), the calculator 292 executes the second calculation processing CP2 (step S140).

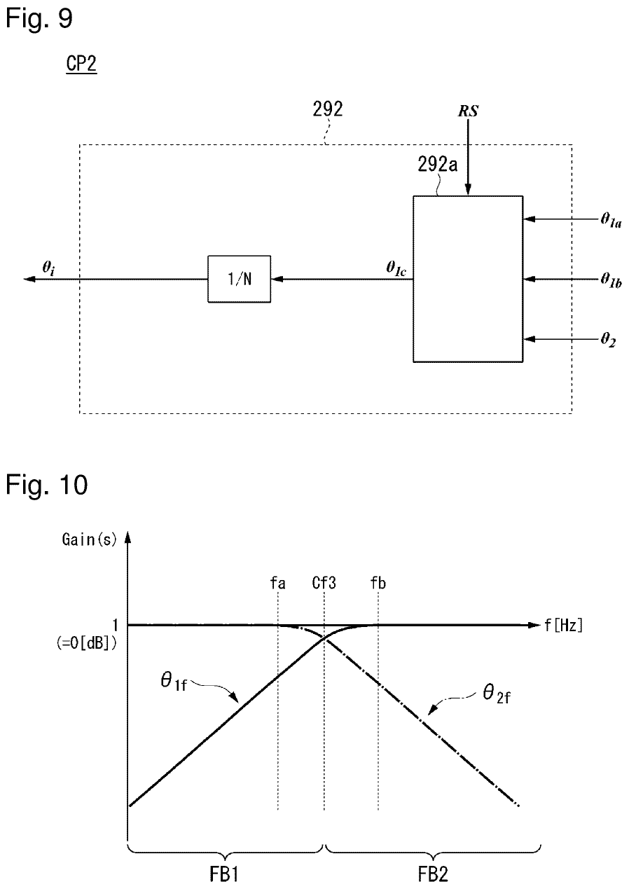

FIG. 8 is a block diagram illustrating the function of the calculator 292 when the first calculation processing CP1 is executed. FIG. 9 is a block diagram illustrating the function of the calculator 292 when the second calculation processing CP2 is executed. As illustrated in FIGS. 8 and 9, the calculator 292 includes a processing determiner 292a. Two first output values θ₁ₐ and θ_{1b}, one second output value θ₂, and the signal RS are input to the processing determiner 292a. The processing to determine the calculation processing to be executed illustrated in FIG. 7 is performed by the processing determiner 292a. As illustrated in FIG. 8, when determining to execute the first calculation processing CP1, the processing determiner 292a outputs the first output value θ_{1c} and the second output value θ₂.

The first output value θ_{1c} is a value calculated based on at least one of the two first output values θ₁ₐ and θ_{1b}. In the present example embodiment, the first output value θ_{1c} is a value used for the first calculation processing CP1 and the second calculation processing CP2 in the calculator 292. When it is determined that no abnormality has occurred in the two first sensors 410, the first output value θ_{1c} is an average value of the two first output values θ₁ₐ and θ_{1b}. That is, when the abnormality determiner 291 determines that no abnormality has occurred in the two first sensors 410, the calculator 292 uses the average value of the two first output values θ₁ₐ and θ_{1b} acquired based on the two first sensors 410 as the first output value θ_{1c} used in the first calculation processing CP1 and the second calculation processing CP2. When it is determined that an abnormality has occurred in one of the first sensors 410 and no abnormality has occurred in the other first sensor 410, the first output value θ_{1c} is a value of the first output value θ₁ acquired based on the first sensor 410 in which no abnormality has occurred out of the two first output values θ₁ₐ and θ_{1b}. That is, when the abnormality determiner 291 determines that an abnormality occurs in one first sensor 410 of the two first sensors 410 and no abnormality has occurred in the other first sensor 410, the calculator 292 uses the first output value θ₁ acquired based on the other first sensor 410 as the first output value θ_{1c} used for the calculation processing.

The first output value θ_{1c} output from the processing determiner 292a in the first calculation processing CP1 is divided by the reduction ratio N, and then subjected to high-pass filter processing in the high-pass filter unit 292H to become a high-frequency output value θ_{1f}. The high-frequency output value θ_{1f} is a value obtained by performing, on the first output value θ_{1c}, high-pass filter processing and division processing of dividing the first output value θ_{1c} by the reduction ratio N of the decelerator 544. The second output value θ₂ output from the processing determiner 292a in the first calculation processing CP1 is subjected to low-pass filter processing in the low-pass filter unit 292L to become a low-frequency output value θ_{2f}. The low-frequency output value θ_{2f} is a value obtained by performing low-pass filter processing on the second output value θ₂. In the present example embodiment, the cutoff frequency of the high-pass filter unit 292H and the cutoff frequency of the low-pass filter unit 292L are the same. That is, in the present example embodiment, the cutoff frequency in the high-pass filter processing performed in the first calculation processing CP1 is the same as the cutoff frequency in the low-pass filter processing performed in the first calculation processing CP1. In the following description, the cutoff frequency of the high-pass filter unit 292H and the cutoff frequency of the low-pass filter unit 292L are referred to as a cutoff frequency Cf3. The cutoff frequency Cf3 is, for example, 10 Hz or more and 100 Hz or less. In the present example embodiment, the cutoff frequency Cf3 is 15 Hz or more and 50 Hz or less. That is, the cutoff frequency Cf3 in the low-pass filter processing and the high-pass filter processing performed in the first calculation processing CP1 of the present example embodiment is 15 Hz or more and 50 Hz or less. The cutoff frequency Cf3 is more preferably 20 Hz or more and 30 Hz or less.

Note that “the cutoff frequency in the high-pass filter processing is the same as the cutoff frequency in the low-pass filter processing” includes not only the case where the cutoff frequency in the high-pass filter processing and the cutoff frequency in the low-pass filter processing are exactly the same as each other, but also the case where the cutoff frequencies are substantially the same as each other. The phrase “the cutoff frequency in the high-pass filter processing and the cutoff frequency in the low-pass filter processing are substantially the same” includes that the cutoff frequency in the high-pass filter processing and the cutoff frequency in the low-pass filter processing are different from each other within a tolerance range such as manufacturing variation of the filter that performs each filter processing.

The gain of the high-frequency output value θ_{1f} and the gain of the low-frequency output value θ_{2f} have, for example, frequency characteristics as illustrated in the graph of FIG. 10. In the graph of FIG. 10, the horizontal axis represents the frequency f [Hz], and the vertical axis represents the gain of each output value. As illustrated in FIG. 10, a frequency band equal to or lower than the cutoff frequency Cf3 is a first frequency band FB1. A frequency band higher than the cutoff frequency Cf3 is a second frequency band FB2.

The gain of the high frequency output value θ_{1f} in the first frequency band FB1 is smaller than the gain of the high frequency output value θ_{1f} in the second frequency band FB2. The gain of the high frequency output value θ_{1f} at the cutoff frequency Cf3 is smaller than 1. The gain of the high frequency output value θ_{1f} at the cutoff frequency Cf3 is, for example, 1/√2, that is, −3 [dB]. The gain of the high frequency output value θ_{1f} is 1 in a frequency band equal to or higher than the frequency fb higher than the cutoff frequency Cf3. In a frequency band lower than the frequency fb, the gain of the high frequency output value θ_{1f} decreases as the frequency f decreases.

The gain of the low frequency output value θ_{2f} in the second frequency band FB2 is smaller than the gain of the low frequency output value θ_{2f} in the first frequency band FB1. The gain of the low frequency output value θ_{2f} at the cutoff frequency Cf3 is smaller than 1. In the example of FIG. 10, the gain of the low frequency output value θ_{2f} at the cutoff frequency Cf3 is the same as the gain of the high frequency output value θ_{1f} at the cutoff frequency Cf3. The gain of the low frequency output value θ_{2f} at the cutoff frequency Cf3 is, for example, 1/√2, that is, −3 [dB]. The gain of the low frequency output value θ_{2f} is 1 in a frequency band equal to or lower than the frequency fa lower than the cutoff frequency Cf3. In a frequency band higher than the frequency fa, the gain of the low frequency output value θ_{2f} decreases as the frequency f increases.

As illustrated in FIG. 8, in the first calculation processing CP1, the high-frequency output value θ_{1f} and the low-frequency output value θ_{2f} are added together by the adder AD4. The adder AD4 adds the high-frequency output value θ_{1f} and the low-frequency output value θ_{2f} together, and outputs the added value as the input value θᵢ. As described above, in the first calculation processing CP1, the calculator 292 calculates the input value θᵢ by adding the high-frequency output value θ_{1f} obtained by performing, on the first output value θ_{1c}, the high-pass filter processing and the division process for dividing the first output value θ_{1c} by the reduction ratio N, and the low-frequency output value θ_{2f} obtained by performing the low-pass filter processing on the second output value θ₂. In other words, the first calculation processing CP1 includes calculating the input value θᵢ by adding the high frequency output value θ_{1f} and the low frequency output value θ_{2f}. As described above, in the first calculation processing CP1, the calculator 292 calculates the input value θᵢ based on the first output value θ₁ acquired based on the first sensor 410 and indicating the output of the motor 543, and the second output value θ₂ acquired based on the second sensor 420 and indicating the output of the decelerator 544. That is, the first calculation processing CP1 includes calculating the input value θᵢ based on the first output value θ₁ and the second output value θ₂.

As illustrated in FIG. 9, when determining to execute the second calculation processing CP2, the processing determiner 292a outputs the first output value θ_{1c} and does not output the second output value θ₂. The first output value θ_{1c} output from the processing determiner 292a in the second calculation processing CP2 is divided by the reduction ratio N to be the input value θᵢ. That is, in the second calculation processing CP2, the calculator 292 sets, as the input value θᵢ, a value obtained by performing division processing on the first output value θ_{1c} by dividing the first output value θ_{1c} by the reduction ratio N of the decelerator 544. In other words, the second calculation processing CP2 includes setting, as the input value θᵢ, a value obtained by performing division processing of dividing the first output value θ_{1c} by the reduction ratio N.

Next, control by the model following controller 230 will be described in more detail. The model following controller 230 controls the control target 560 using the inverse model of the nominal model as the internal model, that is, the inverse nominal model 231. In the present example embodiment, a torque ripple or the like depending on the angular velocity ω of the motor 543 can be compensated by a feedback loop formed by the model following controller 230.

The model following controller 230 is structurally similar to a conventional disturbance estimator (disturbance observer), but has different actions and effects. A conventional disturbance estimator estimates a disturbance torque by using an inverse plant model as an internal model as a model close to the control target 560, and reduces the influence of disturbance by adjusting the disturbance torque in advance.

The control by the model following controller 230 according to the present example embodiment utilizes the effect that the transfer function P(s) of the control target 560 is constrained to the transfer function Pₙ(s) of the nominal model as the internal model, by the feedback loop. For example, if the nominal model is defined such that there is no torque ripple, the transfer function P(s) of the control target 560 is constrained to the characteristic without the torque ripple by the model following control, and as a result, the torque ripple can be reduced by applying torque ripple compensation. By setting the nominal model as a low-inertia model and constraining the control target 560 with the nominal model, the control target 560 can be treated as a low-inertia model. The control target 560 can be treated as a low viscosity model by setting the nominal model as a low viscosity model and constraining the control target 560 with the nominal model. By the model following controller 230 executing model following control, for example, lost torque compensation or motor inertia compensation is performed in addition to compensation of the torque ripple of the motor 543. By appropriately setting Jₙ and Bₙ in Expressions (4) and (5) described above, a desired frequency characteristic can be given to the transfer function P(s) of the control target 560.

When a modeling error between the transfer function P(s) of the control target 560 and the transfer function Pₙ(s) of the nominal model is A(s), the transfer function P(s) of the control target 560 is expressed by the following Expression (6).

$$\begin{matrix}Expression 6 & \\ P ( s ) = \frac{1}{{J}_{n} {s}^{2} + {B}_{n} s} ( 1 + Δ ( s ) ) & ( 6 )\end{matrix}$$

The gain characteristic of the transfer function P(s) of the control target 560 has peaks in two frequency values, for example. The modeling error Δ(s) appears, for example, near the higher frequency peak of the two peaks in the gain characteristic of the control target 560. Therefore, as illustrated in FIG. 4, the reciprocal 1/Δ(s) of the modeling error Δ(s) has a bottom in a relatively high frequency region. In FIG. 4, the modeling error Δ(s) is indicated by an absolute value. When the modeling error Δ(s) increases, the deviation between the transfer function P(s) of the control target 560 and the transfer function Pₙ(s) of the nominal model increases, and the control of the control target 560 using the nominal model by the model following controller 230 becomes unstable. For this reason, in a domain where the modeling error Δ(s) is relatively small, the control target 560 can be stably and suitably controlled by setting the gain of the complementary sensitivity function T(s) to be substantially 1 and constraining the control target 560 to the nominal model. The frequency characteristic of the modeling error Δ(s) can be adjusted by adjusting Jₙ and Bₙ in the transfer function Pₙ(s) of the nominal model. The frequency band where the gain of the complementary sensitivity function T(s) becomes substantially 1 can be adjusted by adjusting the first cutoff frequency Cf1 and the second cutoff frequency Cf2. Consequently, the gain of the complementary sensitivity function T(s) can be adjusted to be substantially 1 in the frequency band where the modeling error Δ(s) is small.

In FIG. 4, 1/Δ(s) is relatively high in a frequency band equal to or lower than the second cutoff frequency Cf2, and rapidly decreases in a frequency band higher than the second cutoff frequency Cf2. The model following control for constraining the control target 560 to the nominal model can be stably performed, for example, in a range where 1/Δ(s) is larger than 1, that is, in a range where 1/Δ(s) is larger than 0 dB. For this reason, as illustrated in FIG. 4, by adjusting 1/Δ(s) to be larger than 1 in a frequency band in which a gain of the complementary sensitivity function T(s) is substantially 1, in the case where a gain of the complementary sensitivity function T(s) is substantially 1, the control target 560 can be constrained to the nominal model to be stably and suitably controlled.

For example, in order to expand a frequency band where the control target 560 can be stably and suitably controlled by constraining the control target 560 to the nominal model, the second cutoff frequency Cf2 may be increased within a range in which 1/Δ(s) is not 1 or less, that is, within a frequency band lower than a frequency at which a curve indicating 1/Δ(s) in FIG. 4 intersects the horizontal axis. However, if the second cutoff frequency Cf2 is made too high, the gain of the complementary sensitivity function T(s) remains relatively high even though 1/Δ(s) becomes low in a frequency band higher than the second cutoff frequency Cf2, and control may become unstable. On the other hand, in the present example embodiment, since the order of the second filter 232b, which is a low-pass filter, is set to third order or more, the gain of the complementary sensitivity function T(s) can be steeply decreased in a region where the frequency is higher than the second cutoff frequency Cf2. As a result, if the second cutoff frequency Cf2 is made relatively high, the gain of the complementary sensitivity function T(s) can be immediately lowered in a frequency band higher than the second cutoff frequency Cf2, so that control of the control target 560 can be prevented from becoming unstable.

Robust stability of the model following controller 230 is guaranteed when the small-gain theorem shown in Expression (7) below is established between the complementary sensitivity function T(s) and the modeling error Δ(s).

$$\begin{matrix}Expression 7 & \\ \begin{matrix}or & ) \vert < \frac{1}{\vert Δ ( j ω ) \vert} , , & \vert T ( j ω ) Δ ( j ω ) \vert < 1 , & ∀ s = j ω\end{matrix} & ( 7 )\end{matrix}$$

As described above, in order to perform model following control using the nominal model in the model following controller 230, the complementary sensitivity gain GT of the complementary sensitivity function T(s) may be substantially 1, but in consideration of robust stability, it is necessary to satisfy Expression (7) above. As understood from this, it is not possible to achieve both setting of the complementary sensitivity gain GT to substantially 1 in all frequency bands and Expression (7), and it is not possible to achieve both reduction in disturbance or the like by the model following controller 230 and robust stability.

As illustrated in FIG. 4, the complementary sensitivity gain GT of the complementary sensitivity function T(s) is smaller than 1 also in a low frequency domain FA1 where the frequency f is lower than the first cutoff frequency Cf1. In a region where the complementary sensitivity gain GT of the complementary sensitivity function T(s) is smaller than 1, the assist controller 210 controls the input torque Tᵣ to control the control target 560. As described above, in a high frequency domain FA2 where the frequency is higher than the second cutoff frequency Cf2, the complementary sensitivity gain GT of the complementary sensitivity function T(s) is greatly lowered, and the correction torque T_{f} from the model following controller 230 is hardly fed back to the input of the control target 560. On the other hand, in the low frequency domain FA1, the complementary sensitivity gain GT of the complementary sensitivity function T(s) is set to a certain magnitude, and the correction torque T_{f} is fed back to the input of the control target 560. In the low frequency domain FA1, a compensation value generated in the assist adjustment unit 270 described above is fed back to the input of the control target 560 according to the complementary sensitivity gain GT of the complementary sensitivity function T(s). In the present example embodiment, the value of the complementary sensitivity gain GT in the low frequency domain FA1 is 0.5 or more. In the present example embodiment, a stationary gain T(0) of the complementary sensitivity function T(s) is 0.5.

In the motor 543 and the decelerator 544, the motor 543 is easier to model, and the decelerator 544 is harder to model. Therefore, in a case where the control target 560 includes the motor 543 and the decelerator 544 as in the present example embodiment, it is easy to make the nominal model a model having a small modeling error with the motor 543, but the nominal model is likely to be complicated in an attempt to reduce the modeling error with the decelerator 544. As a result, there is a problem that the operation load of the control device 100 increases as the nominal model becomes closer to the configuration of the control target 560. On the other hand, when the nominal model is simplified to some extent, the behavior of the decelerator 544 can be simulated to some extent in a low frequency band such as the first frequency band FB1 described above, but it is difficult to simulate the behavior of the decelerator 544 in a high frequency band such as the second frequency band FB2 described above. For this reason, when the nominal model is simplified to some extent, the modeling error Δ(s) with respect to the control target 560 increases in a high frequency band such as the second frequency band FB2. Therefore, in a case where the model following control is executed only based on the output of the decelerator 544, if the nominal model is simplified, it may be difficult to stably execute the model following control in a high frequency band such as the second frequency band FB2.

In view of the above problem, according to the present example embodiment, the control device 100 includes the calculator 292 that calculates the input value θᵢ to be input to the model following controller 230. The model following controller 230 includes the inverse nominal model 231 that is an inverse model of the nominal model and to which the input value θᵢ is input, and is configured such that the transfer function P(s) of the control target 560 is constrained to the transfer function Pₙ(s) of the nominal model in the frequency band in which the complementary sensitivity gain GT that is a gain in the gain characteristic of the complementary sensitivity function T(s) with respect to the modeling error Δ(s) between the control target 560 and the nominal model is substantially 1. The calculator 292 can execute the first calculation processing CP1 to calculate the input value θᵢ. In the first calculation processing CP1, the calculator 292 calculates the input value θᵢ based on the first output value θ₁ acquired based on the first sensor 410 and indicating the output of the motor 543, and the second output value θ₂ acquired based on the second sensor 420 and indicating the output of the decelerator 544. In other words, the control method of controlling the control target 560 includes executing the first calculation processing CP1 to calculate the input value θᵢ to be input to the inverse nominal model 231 in the model following control. The first calculation processing CP1 includes calculating the input value θᵢ based on the first output value θ₁ and the second output value θ₂. Since the motor 543 is more easily modeled than the decelerator 544, the output of the motor 543 can be easily simulated even if the nominal model is simplified to some extent. In addition, in a low frequency band, the behavior of the decelerator 544 is easily simulated even if the nominal model is simplified to some extent, and the output of the decelerator 544 is easily simulated. Therefore, for example, in a high frequency band in which the modeling error Δ(s) of the nominal model is likely to increase, by setting the input value θᵢ at which the model following control is performed using the first output value θ₁ indicating the output of the motor 543 that is likely to be modeled, the model following control can be stably performed even in the high frequency band in which the modeling error Δ(s) is likely to increase. As a result, it is possible to perform stable model following control while reducing the operation load of the control device 100 using the nominal model as a relatively simple model. Therefore, according to the present example embodiment, it is possible to improve the stability of the model following control while suppressing an increase in the operation load of the control device 100. Since the model following control can be stably executed for the control target 560 including the decelerator 544, the torque ripple of the output torque of the decelerator 544 can be suitably reduced.

According to the present example embodiment, in the first calculation processing CP1, the calculator 292 calculates the input value θᵢ by adding a value obtained by performing, on the first output value θ_{1c}, the high-pass filter processing and the division processing for dividing the first output value θ_{1c} by the reduction ratio N of the decelerator 544, that is, the high-frequency output value θ_{1f}, and a value obtained by performing the low-pass filter processing on the second output value θ₂, that is, the low-frequency output value θ_{2f}. In other words, the first calculation processing CP1 includes calculating the input value θᵢ by adding the high frequency output value θ_{1f} and the low frequency output value θ_{2f}. Therefore, the gain of the input value θᵢ can be set to a gain having a frequency characteristic obtained by adding the gain of the high frequency output value θ_{1f} and the gain of the low frequency output value θ_{2f} illustrated in FIG. 10. As a result, the model following control can be accurately executed based on the second output value θ₂ indicating the output of the decelerator 544 in which the modeling error tends to be small in the low first frequency band FB1. In the high second frequency band FB2, the model following control can be stably executed based on the first output value θ₁ indicating the output of the motor 543 in which the modeling error is less likely to increase even in the high frequency band. Therefore, it is possible to stably execute the model following control in a wide frequency band while setting the nominal model as a simple model to some extent. In addition, since it is not necessary to perform control such as switching the output value to be used according to the frequency band, it is possible to further suppress an increase in the operation load of the control device 100.

According to the present example embodiment, the cutoff frequency in the high-pass filter processing of the first calculation processing CP1 is the same as the cutoff frequency in the low-pass filter processing of the first calculation processing CP1. Therefore, in the first calculation processing CP1, it is possible to easily design each filter as compared with the case where the cutoff frequency of the high-pass filter processing and the cutoff frequency of the low-pass filter processing are different from each other. In addition, it is possible to suppress occurrence of a frequency band in which both the gain of the high frequency output value θ_{1f} and the gain of the low frequency output value θ_{2f} are smaller than the gain of each output value at the cutoff frequency Cf3. As a result, it is possible to suppress occurrence of a frequency band in which the model following control becomes unstable.

According to the present example embodiment, the cutoff frequency Cf3 in the low-pass filter processing of the first calculation processing CP1 is 15 Hz or more and 50 Hz or less. The behavior of the decelerator 544 in the frequency band of 15 Hz or more and 50 Hz or less can be easily simulated even with a simple nominal model. Therefore, by setting the cutoff frequency Cf3 in the low-pass filter processing of the first calculation processing CP1 to a frequency in such a frequency band, it is easy to stably execute the model following control while further simplifying the nominal model.

According to the present example embodiment, the control device 100 includes the abnormality determiner 291 that determines whether or not an abnormality has occurred in the two first sensors 410 and the one second sensor 420 based on the two first output values θ₁ₐ and θ_{1b} acquired based on the two first sensors 410 respectively and the one second output value θ₂ acquired based on the one second sensor 420. The abnormality determiner 291 compares three values θ₃ₐ, θ_{3b}, and θ_{3c}, including two values obtained by dividing the two first output values θ₁ₐ and θ_{1b} by the reduction ratio N of the decelerator 544 and one second output value θ₂, with each other, and when one value among the three values θ₃ₐ, θ_{3b}, and θ_{3c} is different from the other two values by a predetermined threshold or more, the abnormality determiner 291 determines that an abnormality has occurred in a sensor used to acquire the one value among three sensors including the two first sensors 410 and the one second sensor 420. In other words, the control method of controlling the control target 560 includes abnormality determination processing to determine whether or not an abnormality has occurred in the two first sensors 410 and the one second sensor 420, based on the two first output values θ₁ₐ and θ_{1b} and the one second output value θ₂. The abnormality determination processing includes comparing the three values θ₃ₐ, θ_{3b}, and θ_{3c} with each other, and when one value among the three values θ₃ₐ, θ_{3b}, and θ_{3c} is different from the other two values by a predetermined threshold or more, determining that an abnormality has occurred in a sensor used to acquire the one value among the three sensors. Therefore, it is possible to detect an abnormality occurring in the three sensors including the two first sensors 410 and the one second sensor 420. In addition, since the transfer function P(s) of the control target 560 can be constrained to the transfer function Pₙ(s) of the nominal model by the model following control, a delay of the output of the decelerator 544 with respect to the output of the motor 543 can be reduced, and an error between the output value of the decelerator 544 calculated from the first output value θ₁ acquired based on the first sensor 410 and the second output value θ₂ acquired based on the second sensor 420 can be reduced. As a result, the difference between the three values θ₃ₐ, θ_{3b}, and θ_{3c} when each sensor is normal can be reduced as compared with the case where the model following control is not executed. Therefore, the predetermined threshold used for abnormality determination can be reduced as compared with the case where the model following control is not performed. Therefore, when an abnormality occurs in any one of the three sensors, the time taken until the difference between one of the three values θ₃ₐ, θ_{3b}, and θ_{3c} and the other two values becomes equal to or more than the predetermined threshold is shortened. As a result, it is possible to quickly detect that an abnormality has occurred in the sensor.

In addition, for example, in a case where an abnormality in the two first sensors 410 is determined by comparing the two first output values θ₁ₐ and θ_{1b} acquired based on the two first sensors 410, it is not possible to determine which of the two first sensors 410 has the abnormality even if the difference between the first output values θ₁ₐ and θ_{1b} is a predetermined threshold or more. On the other hand, for example, when three first sensors 410 are provided and three first output values θ₁ output based on the three first sensors 410 are compared with each other, the first sensor 410 in which an abnormality has occurred can be specified. However, in this case, since it is necessary to increase the number of the first sensors 410 as the third sensor by one, the manufacturing cost of the electric power steering device 1000 increases. On the other hand, in the present example embodiment, since the delay of the output of the decelerator 544 with respect to the output of the motor 543 can be reduced by the model following control, the second sensor 420 for detecting the output of the decelerator 544 can be used as the third sensor to be added to the two first sensors 410. Therefore, it is possible to specify the sensor in which an abnormality has occurred without increasing the number of first sensors 410. Therefore, it is possible to suppress an increase in the manufacturing cost of the electric power steering device 1000.

According to the present example embodiment, each of the three values θ₃ₐ, θ_{3b}, and θ_{3c} is a value subjected to low-pass filter processing. By setting the nominal model that constrains the control target 560 in the model following control as a model including the decelerator 544, it is easy to reduce an error between the output value of the decelerator 544 calculated from the first output value θ₁ and the second output value θ₂ acquired based on the second sensor 420. However, in a case where the nominal model is a model that is somewhat simple and cannot simulate the behavior of the decelerator 544 in a high frequency band such as the second frequency band FB2, the modeling error Δ(s) between the nominal model and the control target 560 increases in the high frequency band. Accordingly, it is difficult to use the second output value θ₂ in the model following control in a high frequency band such as the second frequency band FB2 due to the stability problem. Therefore, in the present example embodiment, in a high frequency band such as the second frequency band FB2, the model following control is executed using the first output value θ₁ indicating the output of the motor 543. However, in this case, it is not possible to obtain the effect of using the nominal model as a model including the decelerator 544, that is, the effect of reducing the error between the output value of the decelerator 544 calculated from the first output value θ₁ and the second output value θ₂ acquired based on the second sensor 420. Therefore, by comparing the three values θ₃ₐ, θ_{3b}, and θ_{3c} from which the high-frequency component has been removed by the low-pass filter processing, the predetermined threshold used when determining the abnormality can be further reduced. Therefore, occurrence of an abnormality in the sensor can be detected more quickly. The lower the cutoff frequency in the low-pass filter processing performed on the three values θ₃ₐ, θ_{3b}, and θ_{3c}, the lower the error between the output value of the decelerator 544 calculated from the first output value θ₁ and the second output value θ₂ acquired based on the second sensor 420. Therefore, in order to reduce the predetermined threshold used for comparison between the three values θ₃ₐ, θ_{3b}, and θ_{3c}, the cutoff frequency in the low-pass filter processing performed on the three values θ₃ₐ, θ_{3b}, and θ_{3c} may be lowered. However, the lower the cutoff frequency, the greater the delay that occurs in the three values θ₃ₐ, θ_{3b}, and θ_{3c}, and the later the timing of processing the values θ₃ₐ, θ_{3b}, and θ_{3c} in which the abnormality appears. Therefore, the time until the abnormality is detected tends to be long. Therefore, the cutoff frequency in the low-pass filter processing applied to the three values θ₃ₐ, θ^{3b}, and θ_{3c} is preferably determined based on a required fault tolerant time interval (FTTI) or the like.

According to the present example embodiment, the calculator 292 can execute the second calculation processing CP2 to calculate the input value θᵢ. When the abnormality determiner 291 determines that no abnormality has occurred in at least one of the two first sensors 410 and the second sensor 420, the calculator 292 calculates the input value θᵢ by the first calculation processing CP1. When the abnormality determiner 291 determines that no abnormality has occurred in at least one of the two first sensors 410 and an abnormality has occurred in the second sensor 420, the calculator 292 calculates the input value θᵢ by the second calculation processing CP2. In the second calculation processing CP2, the calculator 292 sets, as the input value θᵢ, a value obtained by performing division processing on the first output value θ_{1c} by dividing the first output value θ_{1c} by the reduction ratio N of the decelerator 544. In other words, the control method of controlling the control target 560 includes: executing the second calculation processing CP2 to calculate the input value θᵢ, calculating the input value θᵢ by the first calculation processing CP1 when it is determined in the abnormality determination processing that no abnormality has occurred in at least one of the two first sensors 410 and the second sensor 420; and calculating the input value θᵢ by the second calculation processing CP2 when it is determined in the abnormality determination processing that no abnormality has occurred in at least one of the two first sensors 410 and it is determined that an abnormality has occurred in the second sensor 420. The second calculation processing CP2 includes setting, as the input value θᵢ, a value obtained by performing division processing of dividing the first output value θ_{1c} by the reduction ratio N of the decelerator 544. Therefore, even when an abnormality occurs in the second sensor 420, the assist control by the electric power steering device 1000 can be continued by using the first output value θ₁ acquired based on the first sensor 410.

According to the present example embodiment, when the abnormality determiner 291 determines that no abnormality has occurred in the two first sensors 410, the calculator 292 uses the average value of the two first output values θ₁ₐ and θ_{1b} acquired based on the two first sensors 410 as the first output value θ_{1c} used in the first calculation processing CP1. In other words, the control method of controlling the control target 560 includes using the average value of the two first output values θ₁ₐ and θ_{1b} acquired based on the two first sensors 410 as the first output value θ_{1c} used in the first calculation processing CP1 when it is determined that no abnormality has occurred in the two first sensors 410 in the abnormality determination processing. Therefore, the accuracy of the first output value θ_{1c} used for the first calculation processing CP1 can be improved as compared with the case where one of the two first output values θ₁ₐ and θ_{1b} is used as the first output value θ_{1c}. In addition, by setting the average value of the first output values θ₁ₐ and θ_{1b} to the first output value θ_{1c} in the second calculation processing CP2, the accuracy of the first output value θ_{1c} used in the second calculation processing CP2 can be improved.

According to the present example embodiment, when the abnormality determiner 291 determines that an abnormality has occurred in one first sensor 410 of the two first sensors 410 and no abnormality has occurred in the other first sensor 410, the calculator 292 uses the first output value θ₁ acquired based on the other first sensor 410 as the first output value θ_{1c} used for the first calculation processing CP1. In other words, the control method of controlling the control target 560 includes using the first output value θ₁ acquired based on the other first sensor 410 as the first output value θ_{1c} used in the first calculation processing CP1 when it is determined in the abnormality determination processing that the abnormality has occurred in one first sensor 410 of the two first sensors 410 and no abnormality has occurred in the other first sensor 410. Therefore, even if an abnormality occurs in one of the two first sensors 410, the first calculation processing CP1 can be executed, and the assist control by the electric power steering device 1000 can be continued. Similarly, in the second calculation processing CP2, the first output value θ₁ acquired based on the other first sensor 410 is used, so that even if an abnormality occurs in one of the two first sensors 410 and the second sensor 420, the second calculation processing CP2 can be executed, and the assist control by the electric power steering device 1000 can be continued.

At least a portion of the function of each component of the control device 100 described above may be implemented by hardware including a circuit unit such as a large scale integration (LSI), an application specific integrated circuit (ASIC), a field-programmable gate array (FPGA), and a graphics processing unit (GPU), or may be implemented by cooperation of software and hardware. A storage unit in which a program for causing the processor 200 of the control device 100, which is a computer, to execute the above-described control method is stored is realized by, for example, a storage medium such as a random access memory (RAM), a read only memory (ROM), a hard disk drive (HDD), or a flash memory. The storage unit is not particularly limited as long as a program for causing a computer to execute the above-described control method can be stored, and may be a microcomputer or a disk medium such as a CD-ROM. The storage unit may be provided separately from the control device 100. In this case, the control device 100 may communicate with the storage unit by wired communication or wireless communication and execute the program stored in the storage unit.

The present disclosure is not limited to the above-described example embodiments, and other configurations and other methods can be employed within the scope of the technical idea of the present disclosure. In the first calculation processing, the input value input to the inverse nominal model of the model following controller may be calculated in any manner as long as the input value is calculated based on the first output value that is acquired based on the first sensor and indicates the output of the motor and the second output value that is acquired based on the second sensor and indicates the output of the decelerator. The cutoff frequency in the high-pass filter processing of the first calculation processing may be different from the cutoff frequency in the low-pass filter processing of the first calculation processing. The cutoff frequency in the high-pass filter processing of the first calculation processing and the cutoff frequency in the low-pass filter processing of the first calculation processing are not particularly limited. The abnormality determiner may determine an abnormality in the three sensors by comparing three values including two first output values and a value obtained by multiplying one second output value by the reduction ratio of the decelerator. That is, the abnormality determination processing may include determining an abnormality in the three sensors by comparing three values including two first output values and a value obtained by multiplying one second output value by the reduction ratio of the decelerator. The three values compared by the abnormality determiner may be values that have not been subjected to the low-pass filter processing. The abnormality determiner may not be provided.

Example embodiments of the present disclosure can have configurations as described below.
[1]A control device that controls, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control device including a model following controller configured or programmed to generate a correction torque to correct an input torque to be input to the control target based on a nominal model based on a configuration of the control target, and a calculator configured or programmed to calculate an input value to be input to the model following controller, wherein the model following controller is configured or programmed to include an inverse nominal model that is an inverse model of the nominal model and to which the input value is input, and the model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model, the calculator is configured or programmed to execute first calculation processing to calculate the input value, in the first calculation processing, the calculator is configured or programmed to calculate the input value based on a first output value acquired based on a first sensor and indicating an output of the motor and a second output value acquired based on a second sensor and indicating an output of the decelerator.
[2] The control device according to [1], wherein in the first calculation processing, the calculator is configured or programmed to calculate the input value by adding a value obtained by performing, on the first output value, high-pass filter processing and division processing of dividing the first output value by a reduction ratio of the decelerator, and a value obtained by performing low-pass filter processing on the second output value.
[3] The control device according to [2], wherein a cutoff frequency in the high-pass filter processing is same as a cutoff frequency in the low-pass filter processing.
[4] The control device according to [2] and [3], wherein a cutoff frequency in the low-pass filter processing is about 15 Hz or more and about 50 Hz or less.
[5] The control device according to any one of [1] to [4], further including an abnormality determiner configured or programmed to determine whether or not an abnormality has occurred in two of the first sensors and one of the second sensor based on two of the first output values acquired based on the two of the first sensors respectively and one of the second output value acquired based on the one of the second sensor, wherein the abnormality determiner is configured or programmed to compare three values including two values obtained by dividing the two of the first output values by a reduction ratio of the decelerator respectively and the one of the second output value with each other, or three values including the two of the first output values and a value obtained by multiplying the one of the second output value by the reduction ratio with each other, and when one value of the three values is different from other two values by a predetermined threshold or more, the abnormality determiner is configured or programmed to determine that an abnormality has occurred in a sensor used to acquire the one value in three sensors including the two of the first sensors and the one of the second sensor.
[6] The control device according to [5], wherein each of the three values is a value subjected to low-pass filter processing.
[7] The control device according to [5] or [6], wherein the calculator is configured or programmed to execute second calculation processing of calculating the input value, when the abnormality determiner determines that no abnormality has occurred in at least one of the two of the first sensors and the second sensor, the calculator calculates the input value by the first calculation processing, when the abnormality determiner determines that no abnormality has occurred in at least one of the two of the first sensors and determines that an abnormality has occurred in the second sensor, the calculator calculates the input value by the second calculation processing, and in the second calculation processing, the calculator sets, as the input value, a value obtained by performing division processing on the first output value by dividing the first output value by a reduction ratio of the decelerator.
[8] The control device according to any one of [5] to [7], wherein when the abnormality determiner determines that no abnormality has occurred in the two of the first sensors, the calculator is configured or programmed to use an average value of the two of the first output values acquired based on the two of the first sensors respectively, as the first output value to be used in the first calculation processing.
[9] The control device according to any one of [5] to [8], wherein when the abnormality determiner determines that an abnormality has occurred in one of the two of the first sensors and no abnormality has occurred in another of the two of the first sensors, the calculator is configured or programmed to use the first output value acquired based on the other of the two of the first sensors, as the first output value to be used in the first calculation processing.
[10]A motor device including the control device according to any one of [1] to [9], and the motor.
[11] An electric power steering device including the motor device according to [10], and a steering mechanism including the input shaft, the output shaft, and the torsion bar.
[12]A control method of controlling, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control method including executing model following control to generate a correction torque to correct an input torque to be input to the control target based on a nominal model based on a configuration of the control target; constraining a transfer function of the control target to a transfer function of the nominal model in a frequency band in which a complementary sensitivity gain is substantially 1 by the model following control, the complementary sensitivity gain being a gain in a gain characteristic of a complementary sensitivity function with respect to a modeling error between the control target and the nominal model; and executing first calculation processing to calculate the input value to be input to an inverse nominal model that is an inverse model of the nominal model, wherein the first calculation processing includes calculating the input value based on a first output value acquired based on a first sensor and indicating an output of the motor and a second output value acquired based on a second sensor and indicating an output of the decelerator.
[13] The control method according to [12], wherein the first calculation processing, includes calculating the input value by adding a value obtained by performing, on the first output value, high-pass filter processing and division processing of dividing the first output value by a reduction ratio of the decelerator, and a value obtained by performing low-pass filter processing on the second output value.
[14] The control method according to [13], wherein a cutoff frequency in the high-pass filter processing is same as a cutoff frequency in the low-pass filter processing.
[15] The control method according to any one of [12] to [14], further including abnormality determination processing to determine whether or not an abnormality has occurred in two of the first sensors and one of the second sensor based on two of the first output values acquired based on the two of the first sensors respectively and one of the second output value acquired based on the one of the second sensor, wherein the abnormality determination processing includes comparing three values including two values obtained by dividing the two of the first output values by a reduction ratio of the decelerator respectively and the one of the second output value with each other, or three values including the two of the first output values and a value obtained by multiplying the one of the second output value by the reduction ratio with each other, and when one value of the three values is different from other two values by a predetermined threshold or more, determining that an abnormality has occurred in a sensor used to acquire the one value in three sensors including the two of the first sensors and the one of the second sensor.
[16] The control method according to [15], wherein each of the three values is a value subjected to low-pass filter processing.
[17] The control method according to [15] or [16], further including executing second calculation processing to calculate the input value, when it is determined that no abnormality has occurred in at least one of the two of the first sensors and the second sensor in the abnormality determination processing, calculating the input value by the first calculation processing, and when it is determined that no abnormality has occurred in at least one of the two of the first sensors and that an abnormality has occurred in the second sensor in the abnormality determination processing, calculating the input value by the second calculation processing, wherein the second calculation processing includes setting, as the input value, a value obtained by performing division processing on the first output value by dividing the first output value by a reduction ratio of the decelerator.
[18] The control method according to any one of [15] to [17], further including, when it is determined that no abnormality has occurred in the two of the first sensors in the abnormality determination processing, using an average value of the two of the first output values acquired based on the two of the first sensors respectively as the first output value to be used in the first calculation processing.
[19] The control method according to any one of [15] to [18], further including, when it is determined that an abnormality has occurred in one of the two of the first sensors and no abnormality has occurred in another of the two of the first sensors in the abnormality determination processing, using the first output value acquired based on the other of the two of the first sensors as the first output value to be used in the first calculation processing.
[20]A non-transitory computer-readable medium including a program to cause a computer to execute the control method according to any one of [12] to [19].

The configurations and methods described above in the present description can be appropriately combined within a range consistent with each other.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A control device that controls, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control device comprising:
a model following controller configured or programmed to generate a correction torque to correct an input torque to be input to the control target based on a nominal model based on a configuration of the control target; and
a calculator configured or programmed to calculate an input value to be input to the model following controller; wherein
the model following controller is configured or programmed to include an inverse nominal model that is an inverse model of the nominal model and to which the input value is input, and the model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model;
the calculator is configured or programmed to execute first calculation processing to calculate the input value; and
in the first calculation processing, the calculator is configured or programmed to calculate the input value based on a first output value acquired based on a first sensor and indicating an output of the motor and a second output value acquired based on a second sensor and indicating an output of the decelerator.

2. The control device according to claim 1, wherein in the first calculation processing, the calculator is configured or programmed to calculate the input value by adding a value obtained by performing, on the first output value, high-pass filter processing and division processing of dividing the first output value by a reduction ratio of the decelerator, and a value obtained by performing low-pass filter processing on the second output value.

3. The control device according to claim 2, wherein a cutoff frequency in the high-pass filter processing is same as a cutoff frequency in the low-pass filter processing.

4. The control device according to claim 2, wherein a cutoff frequency in the low-pass filter processing is about 15 Hz or more and about 50 Hz or less.

5. The control device according to claim 1, further comprising:
an abnormality determiner configured or programmed to determine whether or not an abnormality has occurred in two of the first sensors and one of the second sensor based on two of the first output values acquired based on the two of the first sensors respectively and one of the second output value acquired based on the one of the second sensor; wherein
the abnormality determiner is configured or programmed to compare three values including two values obtained by dividing the two of the first output values by a reduction ratio of the decelerator respectively and the one of the second output value with each other, or three values including the two of the first output values and a value obtained by multiplying the one of the second output value by the reduction ratio with each other, and when one value of the three values is different from other two values by a predetermined threshold or more, the abnormality determiner is configured or programmed to determine that an abnormality has occurred in a sensor used to acquire the one value in three sensors including the two of the first sensors and the one of the second sensor.

6. The control device according to claim 5, wherein each of the three values is a value subjected to low-pass filter processing.

7. The control device according to claim 5, wherein
the calculator is configured or programmed to execute second calculation processing to calculate the input value;
when the abnormality determiner determines that no abnormality has occurred in at least one of the two of the first sensors and the second sensor, the calculator is configured or programmed to calculate the input value by the first calculation processing;
when the abnormality determiner determines that no abnormality has occurred in at least one of the two of the first sensors and determines that an abnormality has occurred in the second sensor, the calculator is configured or programmed to calculate the input value by the second calculation processing; and
in the second calculation processing, the calculator is configured or programmed to set, as the input value, a value obtained by performing division processing on the first output value by dividing the first output value by a reduction ratio of the decelerator.

8. The control device according to claim 5, wherein when the abnormality determiner determines that no abnormality has occurred in the two of the first sensors, the calculator is configured or programmed to use an average value of the two of the first output values acquired based on the two of the first sensors respectively, as the first output value to be used in the first calculation processing.

9. The control device according to claim 5, wherein when the abnormality determiner determines that an abnormality has occurred in one of the two of the first sensors and no abnormality has occurred in another of the two of the first sensors, the calculator is configured or programmed to use the first output value acquired based on the other of the two of the first sensors as the first output value to be used in the first calculation processing.

10. A motor device comprising:
the control device according to claim 1; and
the motor.

11. An electric power steering device comprising:
the motor device according to claim 10; and
a steering mechanism including the input shaft, the output shaft, and the torsion bar.

12. A control method of controlling, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control method comprising:
executing a model following control to generate a correction torque to correct an input torque to be input to the control target based on a nominal model based on a configuration of the control target;
constraining a transfer function of the control target to a transfer function of the nominal model in a frequency band in which a complementary sensitivity gain is substantially 1 by the model following control, the complementary sensitivity gain being a gain in a gain characteristic of a complementary sensitivity function with respect to a modeling error between the control target and the nominal model; and
executing first calculation processing to calculate the input value to be input to an inverse nominal model that is an inverse model of the nominal model in the model following control; wherein
the first calculation processing includes calculating the input value based on a first output value acquired based on a first sensor and indicating an output of the motor and a second output value acquired based on a second sensor and indicating an output of the decelerator.
